(19) United States
(12) Patent Application Publication
(10) Pub. No.: US 2021/0224925 A1
(43) Pub. Date: Jul. 22, 2021

(54) DETERMINATION METHOD AND INFORMATION PROCESSING APPARATUS

(71) Applicant: FUJITSU LIMITED, Kawasaki-shi (JP)

(72) Inventors: Yasushi Takahashi, Kawasaki (JP); Dai YAMAMOTO, Kawasaki (JP); Jun KOGURE, Kawasaki (JP); Takeshi Miyamae, Kawasaki (JP); Takuya SAKAMOTO, Kawasaki (JP)

(73) Assignee: FUJITSU LIMITED, Kawasaki-shi (JP)

(21) Appl. No.: 17/115,687

(22) Filed: Dec. 8, 2020

(30) Foreign Application Priority Data
Jan. 20, 2020 (JP) 2020-006564

(51) Int. Cl. G06Q 50/00; G06F 16/28; G06Q 10/10

(52) U.S. Cl. CPC G06Q 50/01; G06Q 2220/00; G06Q 10/10; G06F 16/288

(57) ABSTRACT

A determination method performed by a first apparatus corresponding to a first user, the determination method includes acquiring, from a second apparatus corresponding to a second user which is different from the first user, first aggregated information in which identification information for identifying each user having a specific relationship with each user having a specific relationship with the first user is summarized; acquiring, from the second apparatus, second aggregated information in which identification information for identifying each user having a specific relationship with the second user is summarized; identifying a result which indicates a specific relationship between the first user and the second user based on the acquired first aggregated information and the acquired second aggregated information; and outputting the identified result.

### CROSS-REFERENCE TO RELATED APPLICATION

This application is based upon and claims the benefit of priority of the prior Japanese Patent Application No. 2020-6564, filed on Jan. 20, 2020, the entire contents of which are incorporated herein by reference.

### FIELD

The embodiments discussed herein are related to a determination method and an information processing apparatus.

### BACKGROUND

In the related art, there is a technology for determining whether or not a counterpart is trustable based on whether or not a company is indirectly connected to the counterpart by a trust relationship. For example, each company publishes relationship information in which other companies having a trust relationship with the company itself are listed, and when one of companies determines whether or not the other companies are trustable, the company determines whether or not the company is indirectly connected to the other companies by a trust relationship based on the published relationship information.

A technology of the related art provides information for performing authentication evaluation of a terminal of a person to be authenticated, for example, based on an identification tag of the terminal of the person to be authenticated and credit information accumulated in storage means.

For example, Japanese Laid-open Patent Publication No. 2008-312048 and the like are disclosed as the related art.

### SUMMARY

According to an aspect of the embodiments, a determination method performed by a first apparatus corresponding to a first user, the determination method includes acquiring, from a second apparatus corresponding to a second user which is different from the first user, first aggregated information in which identification information for identifying each user having a specific relationship with each user having a specific relationship with the first user is summarized; acquiring, from the second apparatus, second aggregated information in which identification information for identifying each user having a specific relationship with the second user is summarized; identifying a result which indicates a specific relationship between the first user and the second user based on the acquired first aggregated information and the acquired second aggregated information; and outputting the identified result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a determination method according to an embodiment;

FIG. 2 is an explanatory diagram illustrating another example of the determination method according to an embodiment;

FIG. 3 is an explanatory diagram illustrating an example of an information processing system;

FIG. 4 is a block diagram illustrating a hardware configuration example of an information processing apparatus;

FIG. 5 is a block diagram illustrating a functional configuration example of the information processing apparatus;

FIG. 6 is a block diagram illustrating an example of an operation of each functional unit in each information processing apparatus when whether or not a first user and a second user are connected to each other by a trust relationship through a second party is determined;

FIG. 7 is a block diagram illustrating an example of an operation of each functional unit in each information processing apparatus when whether or not a first user and a second user are connected to each other by a trust relationship through a third party is determined;

FIG. 8 is an explanatory diagram illustrating a first operation example of an information processing system;

FIG. 9 is an explanatory diagram illustrating a second operation example of an information processing system;

FIG. 10 is an explanatory diagram illustrating a third operation example of an information processing system;

FIG. 11 is an explanatory diagram illustrating a fourth operation example of an information processing system;

FIG. 12 is an explanatory diagram illustrating a fifth operation example of an information processing system;

FIG. 13 is an explanatory diagram illustrating a sixth operation example of an information processing system;

FIG. 14 is an explanatory diagram illustrating a seventh operation example of an information processing system; and

FIG. 15 is an explanatory diagram illustrating an eighth operation example of an information processing system.

### DESCRIPTION OF EMBODIMENTS

Regarding handling of relationship information of companies, there is a concept called self-sovereign identity (SSI), and there are cases where it is desirable to conceal relationship information of each company without disclosure. However, the related art has a problem that, when whether or not companies are indirectly connected to each other by a trust relationship is determined, relationship information of the respective companies may not be concealed without disclosure.

In view of above description, it is desirable to conceal information indicating presence or absence of a specific relationship between other users in determining presence or absence of a specific relationship through another party between certain users.

Hereinafter, embodiments of a determination method, an information processing apparatus, and an information processing system according to the present disclosure will be described in detail with reference to the drawings.

### Example of Determination Method According to Embodiment

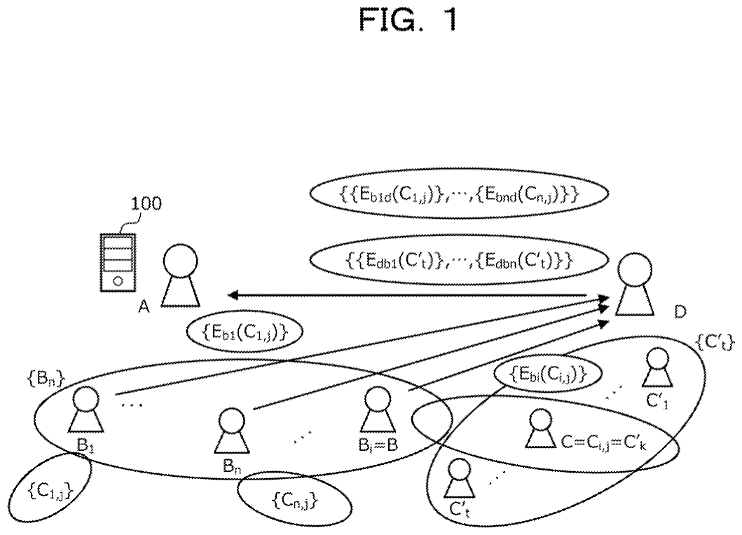

FIG. 1 is an explanatory diagram illustrating an example of a determination method according to an embodiment. An information processing apparatus 100 is a computer that is used by any user and determines whether or not the user has a specific relationship with other users. A user is, for example, an individual or an organization. An organization is, for example, a company. A specific relationship is, for example, a trust relationship. The trust relationship may be a bidirectional relationship of trusting a counterpart or may be a unidirectional relationship of trusting the counterpart.

Recently, it has been desired to determine a trust relationship between individuals or companies in various situations. For example, it is considered that there is an increasing demand for a sharing service and in order to efficiently operate the sharing service, both a user and a provider of the sharing service prove their trustability and determine trustability of a counterpart. The sharing service includes, for example, Uber, Airbnb, Lyft and the like. Meanwhile, the user and the provider of the sharing service are individuals, and it is difficult for the individuals to prove their trustability and to determine trustability of a counterpart.

For example, a situation is considered in which, when a new transaction between companies starts, each company desires to prove its own trustability and to determine trustability of a counterpart. Meanwhile, it is also difficult for a company to prove trustability thereof and to determine trustability of a counterpart, likewise the individuals. For example, when the company proves trustability thereof and determines trustability of the counterpart, time and money costs may increase.

Meanwhile, the following method 1 is considered in which individuals or companies determine whether or not there is an indirect trust relationship between the individual or the companies and a counterpart, as one of methods of determining trustability of the counterpart between the individuals or the companies. For example, even when one company does not directly have a trust relationship with a counterpart, if another company having a trust relationship with the company has a trust relationship with the counterpart, the company may determine that the company may also establish a trust relationship with the counterpart.

For example, in the method 1, each company publishes relationship information in which other companies having a trust relationship with the company are listed, and when determining trustability of other companies, one company determines whether or not there is an indirect trust relationship with other companies based on the published relationship information. If one company has an indirect trust relationship with other companies, the company also establishes a trust relationship with the other companies. For example, in the method 1, the disclosed relationship information is held and managed by a third party.

For example, there is a technology called IDYX. The IDYX is a technology in which records of transactions between companies and evaluations given to each other in the transactions are recorded in a distributed ledger that may not be falsified on a blockchain, and an administrator who is a third party manages the distributed ledger. In IDYX, a company A acquires trustability of a company B calculated by the administrator who is a third party based on the history of transactions recorded in the distributed ledger, and determines whether or not the company B is trustable. For example, Reference Document 1 below may be referred to for the IDYX.

Reference Document 1: Fujitsu Press Release (Jul. 4, 2019): Fujitsu Develops Digital Identity Technology to Evaluate Trustworthiness in Online Transactions, URL: https://pr.fujitsu.com/jp/news/2019/07/4.html

For example, there is a technology called KnowWho. In KnowWho, an administrator who is a third party automatically extracts personal connection information from an application that a user routinely uses, and creates a personal connection structure of each user. The application is, for example, a mailer or a scheduler. In the KnowWho, the user A presents the personal connection structure between the users A and B to the administrator who is a third party, checks a personal connection with the user B, determines trustability of the user B, and determines whether or not to contact the user B. For example, Reference Document 2 below may be referred to for the KnowWho.

Reference Document 2: Yoshiro Katayama, et al. “Semantic Groupware WorkWare++ and Application to KnowWho Retrieval.” Information Processing Society of Japan Research Report Database System (DBS) 2003.51 (2003-DBS-130) (2003): 9-16.

However, as described above, there is a concept called SSI regarding handling of relationship information of individuals or companies, and there is a case in which it is desirable to conceal relationship information of each individual or each company without being disclosed. The SSI is a concept that an individual or a company preferably holds and controls relationship information thereof by itself without having a third party manage the relationship information. Meanwhile, in the above-described method 1, a third party holds and manages relationship information in which other companies having a trust relationship with each company are listed, and the relationship information may not be concealed without being disclosed, and thus, there is a problem that is contrary to the concept of the SSI.

Therefore, in the present embodiment, a determination method will be described in which it is possible to determine whether or not any users are indirectly connected to each other by a specific relationship indirectly through another party while information which is held by each user and indicates a relationship with other users is concealed without being disclosed. In the following description, it is assumed that the specific relationship is mainly, for example, a trust relationship. The trust relationship may be a bidirectional relationship of trusting a counterpart or may be a unidirectional relationship of trusting the counterpart.

In the example of FIG. 1, it is assumed that the information processing apparatus 100 is a first apparatus used by a user A. In the example of FIG. 1, if the user A and another user are indirectly connected to each other by a trust relationship through a second party, it is assumed that the information processing apparatus 100 may treat the user A and another user as having a trust relationship.

In the example of FIG. 1, it is assumed that there are the user A, a user B, a user C, and a user D. In the example of FIG. 1, it is assumed that the user A has a trust relationship with the user B. In the example of FIG. 1, it is assumed that the user B has a trust relationship with the user C. In the example of FIG. 1, it is assumed that the user C has a trust relationship with the user D. For example, the user A is indirectly connected to the user D by a trust relationship through the second party for the users B and C.

Even when the users A to D grasp another user directly having a trust relationship with the users A to D from the concept of SSI, the users A to D may not grasp another user indirectly having a trust relationship with the users A to D. Therefore, it is assumed that the user A does not grasp that the user A is indirectly connected to the user D by a trust relationship through a second party of the users B and C. Likewise, it is assumed that the user D also does not grasp that the user D is indirectly connected to the user A by a trust relationship through the second party of the user B and C.

For example, in the example of FIG. 1, a case will be described in which the information processing apparatus 100 determines whether or not the users A and D are indirectly connected to each other by a trust relationship through a second party. At this time, it is desirable for the information processing apparatus 100 to suppress leakage of the fact that any one of the users A to D has a trust relationship with any user, according to the concept of SSI. It is also desirable for the information processing apparatus 100 to suppress leakage of the fact that the user wants to determine whether or not the user A is indirectly connected to the user D by a trust relationship through a second party according to the concept of SSI.

(1-1) The information processing apparatus 100 acquires first aggregated information from a second apparatus corresponding to a second user. In the example of FIG. 1, the user D corresponds to the second user. The first aggregated information is information in which identification information for identifying each user having a trust relationship with each user having a trust relationship with the first user is summarized. In the example of FIG. 1, the user A corresponds to the first user.

Since the user A corresponds to the first user, the first aggregated information is obtained by summarizing information for identifying each user of a set {C_{i,j}} of users having a trust relationship with each user Bᵢ of a set {Bₙ} of users having a trust relationship with the user A. The set {Bₙ} includes users B₁, . . . , Bᵢ, . . . , Bₙ. i is a natural number of 1 to n. The set {C_{i,j}} includes users C_{i,1}, . . . , C_{i,j}, . . . j is a natural number of 1 or more.

In the first aggregated information, encoding information {E_{bi}(C_{i,j})} obtained by encoding a set {C_{i,j}} of users having a trust relationship with each user Bᵢ may be summarized by an apparatus corresponding to the user B of each of a set {Bₙ} of users. The encoding may a reversible conversion or an irreversible conversion. The encoding is, for example, encryption. The encoding may be, for example, a hash value arithmetic. A subscript of E is information for identifying the encoded apparatus. The encoded first aggregated information may be encoded by a second apparatus corresponding to the user D. The first aggregated information that is multiply encoded is, for example, encoding information {{E_{b1d}(C_{1,j})}, . . . , {E_{bnd}(C_{n,j})}}.

The information processing apparatus 100 receives and acquires, for example, the first aggregated information {{E_{b1d}(C_{i,j})}, . . . , {E_{bnd}(C_{n,j})}} that is multiply encoded, by using the second apparatus corresponding to the user D. According to this, the information processing apparatus 100 uses the second apparatus, and thus, the information processing apparatus 100 may hardly determine whether or not each piece of identification information included in the first aggregated information is an identification information for identifying a user having a trust relationship with any user having a trust relationship with the first user.

(1-2) The information processing apparatus 100 acquires the second aggregated information from the second apparatus corresponding to the second user. The second aggregated information is information in which identification information for identifying each user having a trust relationship with the second user is summarized.

Since the user D corresponds to the second user, the second aggregated information is information in which identification information for identifying each user C′ₖ of a set C′ₜ of users having a trust relationship with the user D is summarized. The set {C′ₜ} includes users C′₁, . . . , C′ₖ, . . . , C′ₜ. k is a natural number of 1 to t.

The second aggregated information may be encoded by the second apparatus corresponding to the user D. The encoded second aggregated information is, for example, encoding information {{E_{d}(C′ₜ)}, . . . , {E_{d}(C′ₜ)}}. The encoded second aggregated information may be encoded by an apparatus corresponding to each user Bᵢ of the set B of users. The second aggregated information that is multiply encoded is encoding information {E_{dbi}(C′ₜ)}.

For example, the information processing apparatus 100 receives and acquires the second aggregated information {{E_{db1}(C′ₜ)}, . . . , {E_{dbn}(C′ₜ)}} that is multiply encoded by using the second apparatus corresponding to the user D. According to this, the information processing apparatus 100 may hardly determine whether or not the second aggregated information that is multiply encoded is the second aggregated information encoded an apparatus corresponding to any user having a trust relationship with the first user, through the second apparatus.

(1-3) The information processing apparatus 100 determines whether or not the first user and the second user indirectly have a trust relationship based on the acquired first aggregated Information and the acquired second aggregated information. The indirect trust relationship is connected by a trust relationship through a second party.

When the first aggregated information and the second aggregated information include a common element, the information processing apparatus 100 determines that the users A and D indirectly have a trust relationship. Meanwhile, when the first aggregated information and the second aggregated information do not include the common element, the information processing apparatus 100 determines that the users A and D do not have a trust relationship.

In the example of FIG. 1, an element relating to the user C=C_{i,j}=C′ₖ may become a common element, and thus, the information processing apparatus 100 determines that the users A and D indirectly have a trust relationship. At this time, even when the first aggregated information and the second aggregated information are encoded, the information processing apparatus 100 determines whether or not the first aggregated information and the second aggregated information include a common element while being encoded.

For example, when the information processing apparatus 100 determines whether or not the first aggregated information and the second aggregated information include the common element while being encoded, it is considered that technology called a privacy set intersection protocol (PSI) is used. For example, Reference Document 3 below may be referred to for PSI.

Reference Document 3: Freedman, Michael J., Kobbi Nissim, and Benny Pinkas. “Efficient private matching and set intersection.” International conference on the theory and applications of cryptographic techniques. Springer, Berlin, Heidelberg, 2004.

Even when it is determined that the users A and D indirectly have a trust relationship, the information processing apparatus 100 may hardly grasp whether or not at least the users A and D are connected to each other by a trust relationship through any user B. The information processing apparatus 100 may determine that the users A and D indirectly have a trust relationship while following the concept of SSI. As described above, the identification information, the first aggregated information, and the second aggregated information are appropriately encoded, and thus, information indicating which user has a trust relationship with each of the users A to D is less likely to be leaked.

A case is described in which, when the user A and another user are indirectly connected to each other by a trust relationship through a second party, the information processing apparatus 100 may treat the user A and another user as having a trust relationship, and the embodiment is not limited thereto. For example, a case may be allowed in which, when the user A and another user are indirectly connected to each other by a trust relationship through a third party, the information processing apparatus 100 may treat the user A and another user as having a trust relationship.

### Another Example of Determination Method According to Embodiment

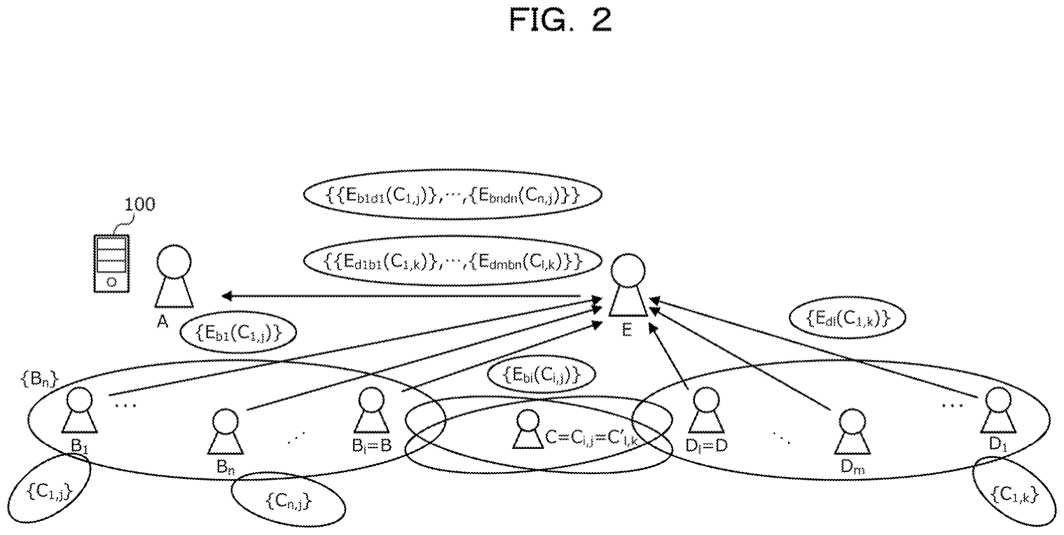

Next, another example of a determination method according to an embodiment will be described with reference to FIG. 2. FIG. 2 is an explanatory diagram illustrating another example of the determination method according to the embodiment.

In the example of FIG. 2, it is assumed that the information processing apparatus 100 is a first apparatus used by the user A. In the example of FIG. 2, when the user A and another user are indirectly connected to each other by a trust relationship through a third party, the information processing apparatus 100 may treat the user A and another user as having a trust relationship.

In the example of FIG. 2, it is assumed that there are the user A, the user B, the user C, the user D, and a user E. In the example of FIG. 2, it is assumed that the user A has a trust relationship with the user B. In the example of FIG. 2, it is assumed that the user B has a trust relationship with the user C. In the example of FIG. 2, it is assumed that the user C has a trust relationship with the user D. In the example of FIG. 2, it is assumed that the user D has a trust relationship with the user E. For example, the user A is indirectly connected to the user E by a trust relationship through a third party of the users B, C, and D.

Even when the users A to E grasp another user directly having a trust relationship with each of the users A to E from a concept of SSI, the users A to E may not grasp another user indirectly having a trust relationship with the users A to D. Thus, it is assumed that the user A does not grasp that the user A is indirectly connected to the user E by a trust relationship through a third party of the users B to D. Likewise, it is assumed that the user E also does not grasp that the user E is indirectly connected to the user A by a trust relationship through the third party of the users B to D.

For example, in the example of FIG. 2, a case will be described in which the information processing apparatus 100 determines whether or not the users A and E are indirectly connected to each other by a trust relationship through a third party. At this time, it is desirable that the information processing apparatus 100 hardly leaks which user has a trust relationship with the users A to E, according to the concept of SSI. It is desirable that the information processing apparatus 100 hardly leaks the fact that the information processing apparatus 100 wants to determine whether or not the user A is indirectly connected to the user E through a third party by a trust relationship according to the concept of SSI.

(1-1) The information processing apparatus 100 acquires first aggregated information from a second apparatus corresponding to a second user. In the example of FIG. 2, the user E corresponds to the second user. The first aggregated information is information in which identification information for identifying each user having a trust relationship with each user having a trust relationship with the first user is summarized. In the example of FIG. 2, the user A corresponds to the first user.

Since the user A corresponds to the first user, the first aggregated information is obtained by summarizing information for identifying each user of a set {C_{i,j}} of users having a trust relationship with each user Bᵢ of a set {Bₙ} of users having a trust relationship with the user A. The set {Bₙ} includes users B₁, . . . , Bᵢ, . . . , Bₙ. i is a natural number of 1 to n. The set {C_{i,j}} includes users C_{i,1}, . . . , C_{i,j}, . . . j is a natural number of 1 or more.

In the first aggregated information, encoding information {E_{b1}(C_{i,j})} obtained by encoding a set {C_{i,j}} of users having a trust relationship with the users B. may be summarized by an apparatus corresponding to each user Bᵢ of a set {Bₙ} of users. The encoded first aggregated information may be encoded by an apparatus corresponding to each user Dₗ of a set Dₘ of users corresponding to the user E. The set Dₘ includes users D₁, . . . , Dₗ, . . . , Dₘ. l is a natural number of 1 to m. The first aggregated information that is multiply encoded is, for example, encoding information {E_{bidl}(C_{i,j})}, respectively.

The information processing apparatus 100 receives and acquires, for example, the first aggregated information {{E_{b1d1}(C_{1,j})}, . . . , {E_{bndm}(C_{n,j})}} that is multiply encoded, by using the second apparatus corresponding to the user E. According to this, the information processing apparatus 100 uses the second apparatus, and thus, the information processing apparatus 100 may hardly determine whether or not each piece of identification information included in the first aggregated information is an identification information for identifying a user having a trust relationship with any user having a trust relationship with the first user.

(1-2) The information processing apparatus 100 acquires second aggregated information from the second apparatus. The second aggregated information is information in which identification information for identifying each user having a specific relationship with each user having a specific relationship with the second user is summarized.

Since the user E corresponds to the second user, the second aggregated information is information in which identification information for identifying each user Dₗ of a set {Dₘ} of users having a trust relationship with the user E and each user C_{l,k} of a set {C_{l,k}} of users having a trust relationship with the user E is summarized. The set {C_{l,k}} includes users C_{l,1}, . . . , C_{l,k}, . . . k is a natural number of 1 or more.

The second aggregated information may information in which encoding information E_{dl}(C_{l,k})} obtained by encoding a set {C_{l,k}} of users having a trust relationship with the user Di by an apparatus corresponding to each user Di of the set {Dₘ} of users is summarized. The encoded second aggregated information may be encoded by an apparatus corresponding to each user B of the set Bₙ of users. The second aggregated information that is multiply encoded is, for example, encoding information {E_{bidl}(C_{l,k})}, respectively.

For example, the information processing apparatus 100 receives and acquires the second aggregated information {{E_{bld1}(C_{1,k})}, . . . , {E_{bndm}(C_{l,k})}} that is multiply encoded, by using the second apparatus corresponding to the user E. According to this, the information processing apparatus 100 uses the second apparatus, and thus, the information processing apparatus 100 may hardly determine whether or not each piece of identification information included in the second aggregated information is identification information for identifying a user having a trust relationship with any user having a trust relationship with the second user.

(1-3) The information processing apparatus 100 determines whether or not the first user and the second user indirectly have a trust relationship based on the acquired first aggregated information and the acquired second aggregated information. An indirect trust relationship is connected by a trust relationship through a third party.

When the first aggregated information and the second aggregated information include a common element, the information processing apparatus 100 determines that the users A and E indirectly have a trust relationship. Meanwhile, when the first aggregated information and the second aggregated information do not include the common element, the Information processing apparatus 100 determines that the users A and E do not have a trust relationship.

In the example of FIG. 2, an element relating to the user C=C_{i,j}=C_{l,k} may become a common element, the information processing apparatus 100 determines that the users A and E indirectly have a trust relationship. At this time, even when the first aggregated information and the second aggregated information are encoded, the information processing apparatus 100 determines whether or not the first aggregated information and the second aggregated information include a common element while being encoded.

Even when it is determined that the users A and E indirectly have a trust relationship, the information processing apparatus 100 may hardly grasp whether or not at least the users A and E are connected to each other by a trust relationship through any user Bᵢ. The information processing apparatus 100 may determine that the users A and E indirectly have a trust relationship while following the concept of SSI. As described above, various types of identification information, the first aggregated information, and the second aggregated information are appropriately encoded, and thus, information indicating which user has a trust relationship with each of the users A to D is less likely to be leaked.

(Example of Information Processing System 200)

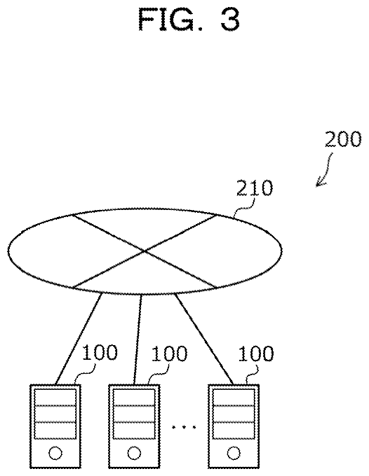

Next, an example of an information processing system 200 to which the information processing apparatuses 100 illustrated in FIGS. 1 and 2 are applied will be described with reference to FIG. 3.

FIG. 3 is an explanatory diagram illustrating the example of the information processing system 200. In FIG. 3, the information processing system 200 includes a plurality of information processing apparatuses 100.

In the information processing system 200, the information processing apparatuses 100 are coupled to each other through a wired or wireless network 210. The network 210 is, for example, a local area network (LAN), a wide area network (WAN), the Internet, or the like.

The information processing apparatus 100 is a computer corresponding to any user. A user is, for example, an individual or an organization. An organization is, for example, a company. For example, the user includes the user A, the user B, the user C, the user D, and the user E. The information processing apparatus 100 stores identification information for identifying another user having a trust relationship with any user corresponding to the information processing apparatus 100. The information processing apparatus 100 determines whether or not any user corresponding to the information processing apparatus 100 is indirectly connected to another user by a trust relationship through another party.

The information processing apparatus 100 is, for example, a personal computer (PC), a tablet terminal, a smartphone, or the like. In the following description, when the information processing apparatuses 100 are distinguished from each other, the information processing apparatus 100 corresponding to a user X may be referred to as an “information processing apparatus 100X”. X is a certain alphabet. X is, for example, A, B, C, D, E, . . . .

The information processing system 200 is used, for example, when a sharing service of a certain article is performed. In this case, the user is, for example, a lender or a borrower of a certain article. The information processing apparatus 100 determines whether or not a lender and a borrower are indirectly connected to each other by a trust relationship through another party, thereby improving convenience of the sharing service.

The information processing system 200 is used for, for example, when an authentication service for confirming a trust relationship between companies is performed. In this case, a user is, for example, a company that performs a transaction. The information processing apparatus 100 determines whether or not the companies that perform transaction are indirectly connected to each other by a trust relationship through another party, thereby improving convenience of the authentication service and Improving safety of the transaction. At this time, the information processing apparatus 100 may reduce time and money cost for determining whether or not the companies that perform the transaction are indirectly connected to each other by a trust relationship through another party.

(Hardware Configuration Example of Information Processing Apparatus 100)

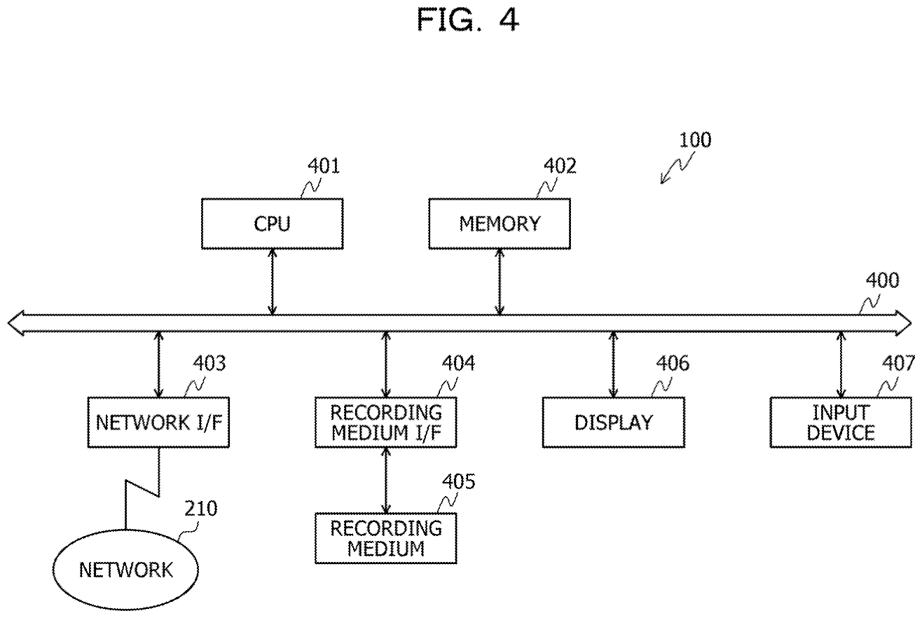

Next, a hardware configuration example of the information processing apparatus 100 will be described with reference to FIG. 4.

FIG. 4 is a block diagram illustrating the hardware configuration example of the information processing apparatus 100. In FIG. 4, the information processing apparatus 100 includes a central processing unit (CPU) 401, a memory 402, a network interface (I/F) 403, a recording medium I/F 404, a recording medium 405, a display 406, and an input device 407. The respective configuration units are coupled to one another through a bus 400.

The CPU 401 controls the entirety of the information processing apparatus 100. The memory 402 includes, for example, a read-only memory (ROM), a random-access memory (RAM), a flash ROM, and the like. For example, the flash ROM and the ROM store various programs, and the RAM is used as a work area of the CPU 401. A program stored in the memory 402 is loaded into the CPU 401, thereby causing the CPU 401 to perform processing of coding.

The network I/F 403 is coupled to the network 210 through a communication line and is coupled to another computer through the network 210. The network I/F 403 controls the network 210 and an internal interface so as to control an input and an output of data from and to the other computer. The network I/F 403 is, for example, a modem, a LAN adapter, or the like.

The recording medium I/F 404 controls read/write of data from/to the recording medium 405 under the control of the CPU 401. The recording medium I/F 404 is, for example, a disk drive, a solid-state drive (SSD), a Universal Serial Bus (USB) port, or the like. The recording medium 405 is a nonvolatile memory that stores the data written under the control of the recording medium I/F 404. The recording medium 405 is, for example, a disk, a semiconductor memory, a USB memory, or the like. The recording medium 405 may be detachable from the information processing apparatus 100.

The display 406 displays not only a cursor, an icon, and a tool box but also data of a document, an image, functional information, and so on. The display 406 is, for example, a cathode ray tube (CRT), a liquid crystal display, an organic electroluminescence (EL) display, or the like. The input device 407 includes keys for inputting letters, numbers, various instructions, and the like, and performs an input of data. The input device 407 may be a keyboard, a mouse, or the like, or may be a touch panel type-input pad, a numeric keypad, or the like.

In addition to the above-described configuration units, the information processing apparatus 100 may include, for example, a printer, a scanner, a microphone, a speaker, and the like. The information processing apparatus 100 may include multiple recording medium I/Fs 404 or multiple recording media 405. The information processing apparatus 100 may not include the recording medium I/F 404 or the recording medium 405.

(Functional Configuration Example of Information Processing Apparatus 100)

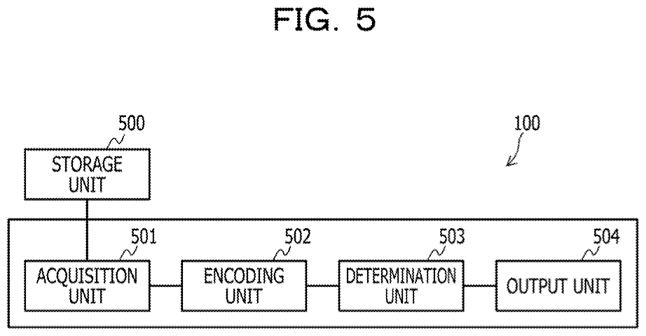

Next, a functional configuration example of the information processing apparatus 100 will be described with reference to FIG. 5 to FIG. 7.

FIG. 5 is a block diagram illustrating a functional configuration example of the information processing apparatus 100. The information processing apparatus 100 includes a storage unit 500, an acquisition unit 501, an encoding unit 502, a determination unit 503, and an output unit 504.

The storage unit 500 is realized by, for example, a storage region of the memory 402, the recording medium 405, or the like illustrated in FIG. 4. A case in which the storage unit 500 is included in the information processing apparatus 100 will be described below, and the embodiment is not limited thereto. For example, a case may be provided in which the storage unit 500 is included in an apparatus different from the information processing apparatus 100 and contents stored in the storage unit 500 may be referred to from the information processing apparatus 100.

The acquisition unit 501 to the output unit 504 function as an example of a control unit. For example, the acquisition unit 501 to the output unit 504 perform functions thereof by causing the CPU 401 to execute a program stored in a storage region of the memory 402, the recording medium 405, and the like illustrated in FIG. 4 or by using the network I/F 403. Results of processing performed by the respective functional units are stored in, for example, the storage region of the memory 402, the recording medium 405, and the like illustrated in FIG. 4.

The storage unit 500 stores various types of information to be referred to or updated in the processing of the respective functional units. The storage unit 500 stores information indicating a trust relationship between any users. The storage unit 500 stores, for example, information indicating a trust relationship between a first user corresponding to the information processing apparatus 100 and another user. For example, the storage unit 500 stores identification information for identifying another user having a trust relationship with the first user corresponding to the information processing apparatus 100. The storage unit 500 stores, for example, information, which is acquired from another apparatus, indicating a trust relationship between any users. The information, which is acquired from another apparatus, indicating the trust relationship between any users may be encoded.

The acquisition unit 501 acquires various types of information used for processing of the respective functional units. The acquisition unit 501 stores the acquired various types of information in the storage unit 500 or outputs the information to the respective functional units. The acquisition unit 501 may output the various types of information stored in the storage unit 500 to the respective functional units. For example, the acquisition unit 501 acquires various types of information based on an operation input by a user. For example, the acquisition unit 501 may receive the various types of information from an apparatus different from the information processing apparatus 100.

For example, the acquisition unit 501 acquires information indicating a trust relationship between any users by reading the information from the storage unit 500. For example, the acquisition unit 501 acquires information indicating a trust relationship between a first user corresponding to the information processing apparatus 100 and another user by reading the information from the storage unit 500. For example, the acquisition unit 501 acquires Identification information for identifying another user having a trust relationship with the first user corresponding to the information processing apparatus 100 by reading the identification information from the storage unit 500. For example, the acquisition unit 501 acquires information indicating a trust relationship between any users by receiving the information from another apparatus. For example, the acquisition unit 501 acquires the encoded information indicating a trust relationship between any users by receiving the information from another apparatus.

The encoding unit 502 encodes information indicating a trust relationship between any users. The encoding may a reversible conversion or an irreversible conversion. The encoding is, for example, encryption. The encoding may be, for example, a hash value arithmetic. For example, the encoding unit 502 encodes information, which is stored in the storage unit 500, indicating a trust relationship between the first user corresponding to the information processing apparatus 100 and another user. For example, the encoding unit 502 encodes identification information for identifying another user having a trust relationship with the first user corresponding to the information processing apparatus 100. The encoding unit 502 encodes, for example, information, which is acquired from another apparatuses, indicating a trust relationship between any users. For example, the encoding unit 502 further encodes the encoded information, which is acquired from another apparatuses, indicating a trust relationship between the users. The encoding unit 502 may generate aggregated information by summarizing a plurality of pieces of information indicating the trust relationship between the users.

The determination unit 503 determines whether or not a first user corresponding to the information processing apparatus 100 and a second user corresponding to another apparatuses have a trust relationship. For example, the determination unit 503 determines whether or not the first user corresponding to the information processing apparatus 100 and the second user corresponding to another apparatuses have a trust relationship, based on information, which is acquired from another apparatuses, indicating a trust relationship between any users. For example, the determination unit 503 determines whether or not the first user corresponding to the information processing apparatus 100 and the second user corresponding to another apparatuses indirectly have a trust relationship through another party.

When it is determined that the first user and the second user indirectly have a trust relationship, the determination unit 503 may automatically set the first user and the second user as a set of new users having a direct trust relationship. At this time, the determination unit 503 automatically adds information indicating that the first user and the second user have a direct trust relationship, to the storage unit.

The output unit 504 transmits information indicating a trust relationship between any users to other apparatuses. The output unit 504 transmits, for example, information, which is encoded by the encoding unit 502, indicating a trust relationship between the first user corresponding to the information processing apparatus 100 and another user to another apparatuses. For example, the output unit 504 transmits identification information, which is encoded by the encoding unit 502, for identifying another user having a trust relationship with the first user corresponding to the information processing apparatus 100 to another apparatuses. For example, the output unit 504 transmits information, which is acquired by the acquisition unit 501 and encoded by the encoding unit 502, indicating a trust relationship between any users to the another apparatuses.

The output unit 504 may output processing results of a certain functional unit. An output type is, for example, displaying on a display, outputting to a printer for printing, transmitting to an external apparatus through the network I/F 403, or storing in a storage region of the memory 402, the recording medium 405, or the like. The output unit 504 outputs, for example, a result of the determination unit 503 that determines whether or not the first user and the second user have a trust relationship. Thereby, the output unit 504 enables the first user to grasp the result of determining whether or not the first user and the second user have a trust relationship.

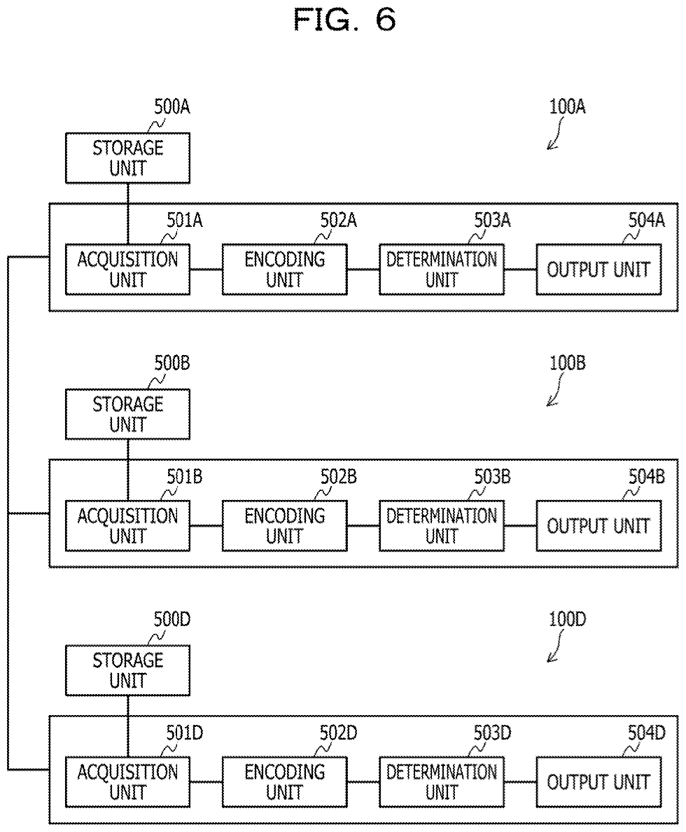

Next, by referring to FIG. 6, an example of an operation of each functional unit in each of the information processing apparatuses 100, when any of the information processing apparatuses 100 determines whether or not the first user and the second user are connected to each other by a trust relationship through a second party, will be described. The first user is a user corresponding to the information processing apparatus 100. The second user is a user corresponding to an another apparatus.

In the example of FIG. 6, it is assumed that there are an information processing apparatus 100A corresponding to a user A, an information processing apparatus 100B corresponding to a user B, an information processing apparatus 100C corresponding to a user C, and an information processing apparatus 100D corresponding to a user D. In the following description, when respective functional units of a different information processing apparatus 100 are distinguished from each other, a symbol “X” may be attached to ends of respective functional units of an information processing apparatus 100X. X is a certain alphabet. X is, for example, A, B, C, D, E, . . . .

FIG. 6 is a block diagram illustrating an example of operations of respective functional units in each information processing apparatus 100 when whether or not a first user and a second user are connected to each other by a trust relationship through a second party is determined.

In FIG. 6, an acquisition unit 501A receives first aggregated information from an output unit 504D. The first aggregated information is information in which identification information for identifying each user having a trust relationship with each user having a trust relationship with the first user is summarized.

The first aggregated information may be encoded by, for example, an encoding unit 502D.

The first aggregated information may be information in which an order of identification information for identifying each user having a trust relationship with each user having a trust relationship with the first user is randomized and summarized by, for example, the encoding unit 502D. The randomization is to randomly sort the order.

The acquisition unit 501A receives, from an output unit 504B corresponding to each user having a trust relationship with the first user, identification information for identifying each user having a trust relationship with the users.

For example, the acquisition unit 501A receives, for example, from the output unit 504B corresponding to each user having the trust relationship with the first user, identification information, which is encoded by an encoding unit 502B, for identifying each user having a trust relationship with the users.

An acquisition unit 501A receives first aggregated information which is transmitted by an output unit 504D and in which the identification information for identifying each user having a trust relationship with each user having a trust relationship with the first user is summarized, from an output unit 504A.

The acquisition unit 501A receives second aggregated information from the output unit 504D. The second aggregated information is information in which identification information for identifying each user having a trust relationship with the second user is summarized.

The second aggregated information may be encoded by, for example, the encoding unit 502D. The second aggregated information may be encoded by, for example, the encoding unit 502B.

The acquisition unit 501A receives the second aggregated information that is encoded by the encoding unit 502B corresponding to each user having a trust relationship with the first user and is transmitted by the output unit 504A, from the output unit 504B.

The acquisition unit 501A receives third aggregated information, which is transmitted by the output unit 504A, from the output unit 504D. The third aggregated information is information which is encoded by the encoding unit 502B and in which the second aggregated information received by the acquisition unit 501A is summarized. The third aggregated information may be encoded by the encoding unit 502D. The acquisition unit 501A receives the third aggregated information that is encoded by the encoding unit 502D and is transmitted by the output unit 504A, from the output unit 504D.

The acquisition unit 501A receives, from the output unit 504D, the third aggregated information which is transmitted by the output unit 504A and in which an order of the second aggregated information is randomized and resummarized by the encoding unit 502D.

An encoding unit 502A encodes identification information for identifying each user having a trust relationship with each user having a trust relationship with the first user.

The encoding unit 502A generates the third aggregated information by summarizing the second aggregated information that is encoded by the encoding units 502B corresponding to each user having a trust relationship with the first user and is received by the acquisition unit 501A.

The encoding unit 502A encodes the third aggregated information.

A determination unit 503A determines whether or not the first user and the second user have a trust relationship with each other. For example, the determination unit 503A determines whether or not the first user and the second user have a trust relationship with each other based on the first aggregated information received by the acquisition unit 501A and the second aggregated information received by the acquisition unit 501A.

The determination unit 503A determines whether or not, for example, the first user and the second user are indirectly connected to each other by a trust relationship through second parties of any user having a trust relationship with the first user and any user having a trust relationship with the second user.

The determination unit 503A determines whether or not the first user and the second user have a trust relationship with each other, for example, based on the first aggregated information and the generated third aggregated information.

The determination unit 503A determines whether or not the first user and the third user have a trust relationship with each other, for example, based on the first aggregated information and the second aggregated information that is encoded by the encoding unit 502D and is received by the acquisition unit 501A.

The determination unit 503A determines whether or not the first user and the second user have a trust relationship with each other based on, for example, the first aggregated information and the third aggregated information in which an order of the second aggregated information is randomized and resummarized by the encoding unit 502D.

The determination unit 503A determines whether or not the first user and the second user have a trust relationship with each other, for example, based on the first aggregated information and the third aggregated information encoded by the encoding unit 502A.

The output unit 504A transmits identification information, which is received by the acquisition unit 501A, for identifying each user having a trust relationship with each user having a trust relationship with the first user, to an acquisition unit 501D.

The output unit 504A transmits identification information, which is received by the acquisition unit 501A and is encoded by the encoding unit 502B corresponding to each user having a trust relationship with the first user, for identifying each user having a trust relationship with the users, to the acquisition unit 501D.

The output unit 504A transmits identification information, which is encoded by the encoding unit 502A, for identifying each user having a trust relationship with each user having a trust relationship with the first user, to the acquisition unit 501D.

The output unit 504A transmits the second aggregated information received by the acquisition unit 501A to the acquisition unit 501B corresponding to each user having a trust relationship with the first user.

The output unit 504A transmits third aggregated information generated by the encoding unit 502A to the acquisition unit 501D.

The output unit 504A outputs a result of the determination unit 503A that determines whether or not the first user and the second user have a trust relationship with each other.

The acquisition unit 501B acquires identification information for identifying each user having a trust relationship with a user corresponding to the information processing apparatus 100, from the storage unit 500B.

The acquisition unit 501B receives the second aggregated information from the output unit 504A.

The encoding unit 502B encodes identification information, which is acquired by the acquisition unit 501, for identifying each user having a trust relationship with a user corresponding to the information processing apparatus 100.

The encoding unit 502B encodes the second aggregated information received by the acquisition unit 501B.

The output unit 504B transmits identification information, which is encoded by the encoding unit 502, for identifying each user having a trust relationship with a user corresponding to the information processing apparatus 100, to the acquisition unit 501A.

The output unit 504B transmits the second aggregated information received by the acquisition unit 501B and encoded by the encoding unit 502B to the acquisition unit 501A.

The acquisition unit 501D receives, from the output unit 504A, identification information for Identifying each user having a trust relationship with each user having a trust relationship with the first user.

The acquisition unit 501D receives, from the output unit 504A, identification information, which is encoded by the encoding unit 502B corresponding to each user having a trust relationship with the first user, for identifying each user having a trust relationship with the users.

The acquisition unit 501D receives, from the output unit 504A, identification information, which is encoded by the encoding unit 502A, for identifying each user having a trust relationship with each user having a trust relationship with the first user.

The acquisition unit 501D receives the third aggregated information generated by the encoding unit 502A from the output unit 504A.

The encoding unit 502D generates first aggregated information. The encoding unit 502D generates the first aggregated information by randomizing and summarizing an order of identification information for identifying each user having a trust relationship with each user having a trust relationship with the first user. The randomization is to randomly sort, for example, identification information for identifying each user having a trust relationship with each user having a trust relationship with the first user, from an order received by the acquisition unit 501D.

The encoding unit 502D generates first aggregated information by summarizing identification information, which is received by the acquisition unit 501D, for identifying each user having a trust relationship with each user having trust relationship with the first user.

The encoding unit 502D summarizes the identification information, which is received by the acquisition unit 501D and encoded by the encoding unit 502B corresponding to each user having a trust relationship with the first user, for identifying each user having a trust relationship with the users. Thereby, the encoding unit 502D generates the first aggregated information.

The encoding unit 502D generates the first aggregated information by summarizing identification information, which is received by the acquisition unit 501D and encoded by the encoding unit 502A, for identifying each user having a trust relationship with each user having a trust relationship with the first user.

The encoding unit 502D encodes the first aggregated information.

The encoding unit 502D encodes third aggregated information received by the acquisition unit 501D.

The encoding unit 502D resummarizes the third aggregated information received by the acquisition unit 501D by randomizing an order of the second aggregated information. The randomization is to randomly resort the order of the second aggregated information, for example, in the third aggregated information.

The output unit 504D transmits the first aggregated information to the acquisition unit 501A.

The output unit 504D transmits, for example, the first aggregated information generated by the encoding unit 502D to the acquisition unit 501A.

The output unit 504D transmits, for example, the first aggregated information encoded by the encoding unit 502D to the acquisition unit 501A.

The output unit 504D transmits the second aggregated information to the acquisition unit 501A.

The output unit 504D transmits the third aggregated information encoded by the encoding unit 502D and received by the acquisition unit 501D to the acquisition unit 501A.

The output unit 504D transmits the third aggregated information which is received by the acquisition unit 501D and in which an order of the second aggregated information is randomized and resummarized by the encoding unit 502D, to the acquisition unit 501A.

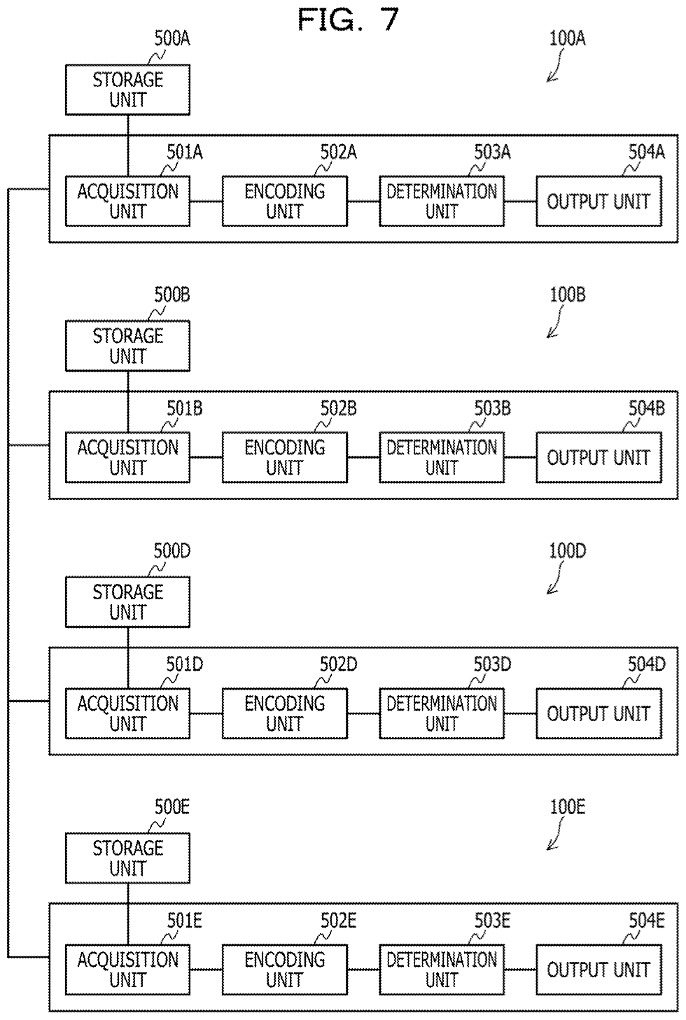

Next, by referring to FIG. 7, an example of an operation of each functional unit in each of the information processing apparatuses 100 when any of the information processing apparatuses 100 determines whether or not the first user and the second user are connected to each other by a trust relationship through a third party will be described. The first user is a user corresponding to the information processing apparatus 100. The second user is a user corresponding to an another apparatus.

In the example of FIG. 7, it is assumed that there are the information processing apparatus 100A corresponding to the user A, the information processing apparatus 100B corresponding to the user 8, the information processing apparatus 100C corresponding to the user C, the information processing apparatus 100D corresponding to the user D, and an information processing apparatus 100E corresponding to a user E. In the following description, when respective functional units of a different information processing apparatus 100 are distinguished from each other, a symbol “X” may be attached to ends of symbols of respective functional units of an information processing apparatus 100X. X is a certain alphabet. X is, for example, A, B, C, D, E, . . . .

FIG. 7 is a block diagram illustrating an example of an operation of each functional unit in each information processing apparatus 100 when whether or not a first user and a second user are connected to each other by a trust relationship through a third party is determined.

In FIG. 7, the acquisition unit 501A receives first aggregated information from the output unit 504E. The first aggregated information is, for example, information in which identification information for identifying each user having a trust relationship with each user having a trust relationship with the first user is summarized.

The acquisition unit 501A receives the first aggregated information encoded by the encoding unit 502D corresponding to each user having a trust relationship with the second user, from an output unit 504E.

The acquisition unit 501A receives, from the output unit 504E, the first aggregated information in which an order of Identification information for identifying each user having a trust relationship with each user having a trust relationship with the first user is randomized and resummarized by the encoding unit 502D.

The acquisition unit 501A receives, from an output unit 504B corresponding to each user having a trust relationship with the first user, identification information for identifying each user having a trust relationship with the users.

The acquisition unit 501A receives, from the output unit 504E, the first aggregated information which is transmitted by the output unit 504A and in which the identification information for identifying each user having a trust relationship with each user having a trust relationship with the first user is summarized.

The acquisition unit 501A receives, from the output unit 504B corresponding to each user having a trust relationship with the first user, the identification information, which is encoded by the encoding unit 502B, for identifying each user having a trust relationship with the users.

The acquisition unit 501A receives, from the output unit 504E, the first aggregated information which is encoded by the encoding unit 502B corresponding to each user having a trust relationship with the first user and in which identification information for identifying each user having a trust relationship with the users is summarized.

The acquisition unit 501A receives, from the output unit 504E, the first aggregated information which is transmitted by the output unit 504A and is encoded by the encoding unit 502A and in which identification information for identifying each user having a trust relationship with each user having a trust relationship with the first user is summarized.

The acquisition unit 501A receives second aggregated information from the output unit 504E. The second aggregated information is, for example, information in which identification information for identifying each user having a trust relationship with each user having a trust relationship with the second user is summarized.

The acquisition unit 501A receives, from the output unit 504E, the second aggregated information in which identification information, which is encoded by the encoding units 502D corresponding to each user having a trust relationship with the second users, for identifying each user having a trust relationship with the users is summarized.

The acquisition unit 501A receives the second aggregated information that is encoded by the encoding unit 502B corresponding to each user having a trust relationship with the first user and is transmitted by the output unit 504A, from the output unit 504B.

The acquisition unit 501A receives, from the output unit 504E, the fourth aggregated information that is encoded by the encoding units 502D corresponding to each user having a trust relationship with the second user and is transmitted by the output unit 504A.

The acquisition unit 501A receives, from the output unit 504E, fourth aggregated information which is transmitted by the output unit 504A and in which an order of the second aggregated information is randomized and resummarized by the encoding units 502D corresponding to each user having a trust relationship with the second user.

An encoding unit 502A encodes identification information for identifying each user having a trust relationship with each user having a trust relationship with the first user.

The encoding unit 502A generates the fourth aggregated information by summarizing the second aggregated information that is encoded by the encoding unit 502B corresponding to each user having a trust relationship with the first user and is received by the acquisition unit 501A.

The encoding unit 502A encodes the fourth aggregated information.

A determination unit 503A determines whether or not the first user and the second user have a trust relationship with each other. The determination unit 503A determines whether or not the first user and the second user are indirectly connected to each other by a trust relationship through a third party. The third party includes any user having a trust relationship with the first user, a second party of any user having a trust relationship with the second user, and any user having a trust relationship with the second party.

For example, the determination unit 503A determines whether or not the first user and the second user have a trust relationship with each other based on the first aggregated information received by the acquisition unit 501A and the second aggregated information received by the acquisition unit 501A.

The determination unit 503A determines whether or not the first user and the fourth user have a trust relationship with each other based on the first aggregated information and the second aggregated information generated by the encoding unit 502A.

The determination unit 503A determines whether or not the first user and the second user have a trust relationship with each other based on the first aggregated information and the fourth aggregated information encoded by the encoding units 502D corresponding to each user having a trust relationship with the second user.

The determination unit 503A determines whether or not the first user and the second user have a trust relationship with each other based on the first aggregated information and the fourth aggregated information in which an order of the second aggregated information is randomized and resummarized by the encoding unit 502D.

The determination unit 503A determines whether or not the first user and the second user have a trust relationship with each other based on the first aggregated information and the fourth aggregated information encoded by the encoding unit 502A.

The output unit 504A transmits the identification information, which is received by the acquisition unit 501A, for identifying each user having a trust relationship with each user having a trust relationship with the first user, to the acquisition unit 501E.

The output unit 504A transmits identification information, which is received by the acquisition unit 501A and is encoded by the encoding units 502B corresponding to each user having a trust relationship with the first user, for identifying each user having a trust relationship with the users, to the acquisition unit 501E.

The output unit 504A transmits identification information, which is encoded by the encoding unit 502A, for identifying each user having a trust relationship with each user having a trust relationship with the first user, to the acquisition unit 501E.

The output unit 504A transmits the second aggregated information received by the acquisition unit 501A to the acquisition unit 501B corresponding to each user having a trust relationship with the first user.

The output unit 504A transmits the fourth aggregated information generated by the encoding unit 502A to the acquisition unit 501E.

The acquisition unit 501B acquires identification information for identifying each user having a trust relationship with a user corresponding to the information processing apparatus 100, from the storage unit 500B.

The acquisition unit 501B receives the second aggregated information from the output unit 504A.

The encoding unit 502B transmits identification information, which is acquired by the acquisition unit 501B, for identifying each user having a trust relationship with a user corresponding to the information processing apparatus 100, to the acquisition unit 501A.

The encoding unit 502B encodes the second aggregated information received by the acquisition unit 501B.

The output unit 504B transmits identification information, which is encoded by the encoding unit 502B, for identifying each user having a trust relationship with a user corresponding to the information processing apparatus 100, to the acquisition unit 501A.

The output unit 504B transmits the second aggregated information encoded by the encoding unit 502B to the acquisition unit 501A.

The acquisition unit 501D acquires identification information for identifying each user having a trust relationship with a user corresponding to the information processing apparatus 100, from the storage unit 500D.

The acquisition unit 501D receives the first aggregated information from the output unit 504E.

The acquisition unit 501D receives the fourth aggregated information generated by the encoding unit 502A from the output unit 504E.

The encoding unit 502D transmits identification information, which is acquired by the acquisition unit 501D, for identifying each user having a trust relationship with a user corresponding to the information processing apparatus 100, to the acquisition unit 501E.

The encoding unit 502D encodes the first aggregated information received by the acquisition unit 501D.

The encoding unit 502D generates the first aggregated information by randomizing and resummarizing an order of identification information for identifying each user having a trust relationship with each user having a trust relationship with the first user.

The encoding unit 502D encodes the fourth aggregated information acquired by the acquisition unit 501D.

The encoding unit 502D resummarizes the fourth aggregated information acquired by the acquisition unit 501D by randomizing an order of the second aggregated information.

The output unit 504D transmits the identification information, which is encoded by the encoding unit 502D, for identifying each user having a trust relationship with a user corresponding to the information processing apparatus 100, to the acquisition unit 501E.

The output unit 504D transmits the first aggregated information that is encoded by the encoding unit 502D and is received by the acquisition unit 501D to the acquisition unit 501E.

The output unit 504D transmits the first aggregated information in which the order of the identification information for identifying each user having a trust relationship with each user having a trust relationship with the first user are randomized and resummarized by the encoding unit 502D, to the acquisition unit 501E.

The output unit 504D transmits the fourth aggregated information encoded by the encoding unit 502D to the acquisition unit 501E.

The output unit 504D transmits the fourth aggregated information in which an order of the second aggregated information is randomized and resummarized by the encoding unit 502D, to the acquisition unit 501E.

The acquisition unit 501E receives, from the output unit 504A, identification information for Identifying each user having a trust relationship with each user having a trust relationship with the first user.

The acquisition unit 501E receives, from the output unit 504A, identification information, which is encoded by the encoding unit 502B corresponding to each user having a trust relationship with the first user, for identifying each user having a trust relationship with the users.

The acquisition unit 501E receives, from the output unit 504A, identification information, which is encoded by the encoding unit 502A, for identifying each user having a trust relationship with each user having a trust relationship with the first user.

The acquisition unit 501E receives, from the output unit 504D, the first aggregated information that is encoded by the encoding unit 502D and is transmitted by the output unit 504E.

The acquisition unit 501E receives, from the output unit 504D, identification information, which is encoded by the encoding unit 502D corresponding to each user having a trust relationship with the second user, for identifying each user having a trust relationship with the users.

The acquisition unit 501E receives the fourth aggregated information generated by the encoding unit 502A from the output unit 504A.

The acquisition unit 501E receives the fourth aggregated information encoded by the encoding unit 502D from the output unit 504D.

The acquisition unit 501E receives, from the output unit 504D, the fourth aggregated information in which an order of the second aggregated information is randomized and resummarized by the encoding unit 502D.

An encoding unit 502E generates first aggregated information. The encoding unit 502E generates the first aggregated information by summarizing identification information, which received by the acquisition unit 501E, for identifying each user having a trust relationship with each user having a trust relationship with the first user.

The encoding unit 502E generates the first aggregated information by summarizing the identification information that is received by the acquisition unit 501E and is encoded by the encoding unit 502A, for identifying each user having a trust relationship with each user having a trust relationship with the first user.

The encoding unit 502E generates the first aggregated information by summarizing identification information, which is encoded by the encoding unit 502B corresponding to each user having a trust relationship with the first user, for identifying each user having a trust relationship with the user.

The encoding unit 502E generates second aggregated information. The encoding unit 502E generates the second aggregated information by summarizing identification information, which is encoded by the encoding unit 502D corresponding to each user having a trust relationship with the second user, for identifying each user having a trust relationship with the users.

The output unit 504E transmits the first aggregated information generated by the encoding unit 502E to the acquisition unit 501A.

The output unit 504E transmits the first aggregated information that is received by the acquisition unit 501E and is encoded by the encoding unit 502D to the acquisition unit 501A.

The output unit 504E transmits the first aggregated information in which an order of the identification information for identifying each user having a trust relationship with each user having a trust relationship with the first user is randomized and resummarized by the encoding unit 502D, to the acquisition unit 501A.

The output unit 504E transmits the first aggregated information generated by the encoding unit 502E to the acquisition unit 501D.

The output unit 504E transmits the second aggregated information generated by the encoding unit 502E to the acquisition unit 501A.

The output unit 504E transmits the fourth aggregated information generated by the encoding unit 502A to the acquisition unit 501D.

The output unit 504E transmits the fourth aggregated information encoded by the encoding unit 502D to the acquisition unit 501A.

The output unit 504E transmits the second aggregated information in which an order of the fourth aggregated information is randomized and resummarized by the encoding unit 502D, to the acquisition unit 501A. [0226] (First to Fourth Operation Examples of Information Processing System 200)

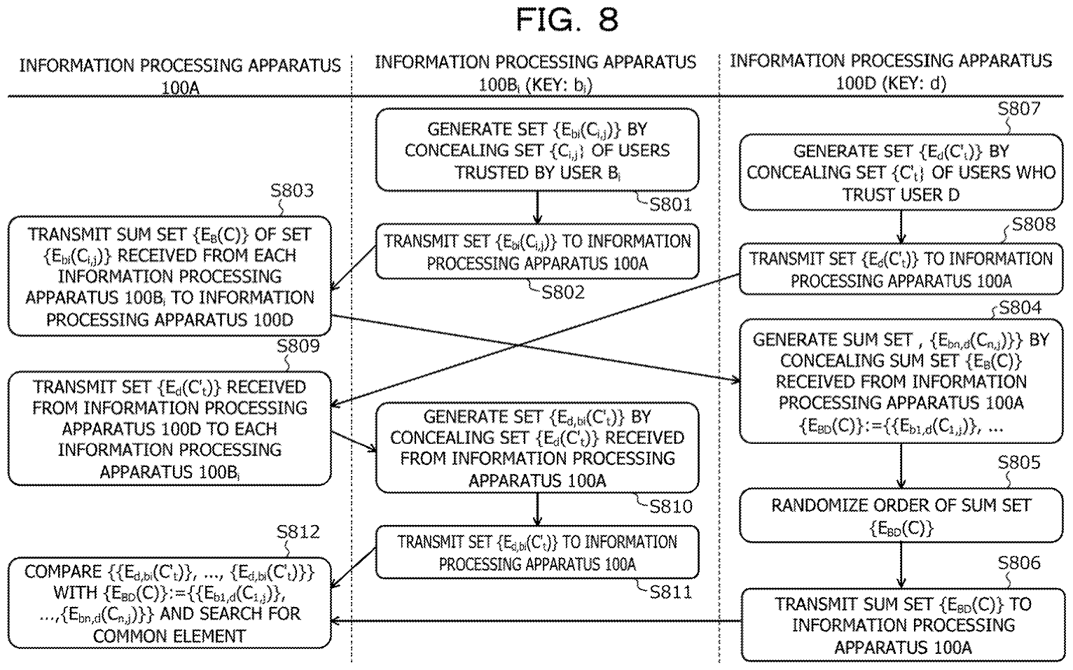

Next, first to fourth operation examples of the information processing system 200 will be described with reference to FIGS. 8 to 11. Each of the first to fourth operation examples corresponds to a case in which the information processing apparatus 100 determines whether or not the first user and the second user are Indirectly connected to each other by a trust relationship through a second party.

FIG. 8 is an explanatory diagram illustrating the first operation example of the information processing system 200. For example, FIG. 8 is a sequence diagram of the information processing system 200 that performs the first operation example.

In FIG. 8, at least, the information processing apparatus 1008, generates a key b corresponding to a user Bᵢ based on an operation input of the user Bᵢ and conceals the key to retain. The user Bᵢ is an ith user Bᵢ included in a set {Bᵢ}:={B₁, . . . , Bₙ} of users directly trusted by the user A. i=1 to n. For example, the set of users is a set of user IDs. At least, the information processing apparatus 100D generates a key d corresponding to the user D based on an operation input of the user D and conceals the key to retain.

The user A wants to determine whether or not the user D is trustable and performs an operation input to the information processing apparatus 100A. The information processing apparatus 100A transmits various requests to each information processing apparatus 10B and the information processing apparatus 100D, based on the operation input of the user A. For example, the information processing apparatus 100A transmits a request to transmit a set {C_{i,j}}:={C_{i,1}, . . . , C_{i,si}} of users trusted by the user BR to each information processing apparatus 100B. For example, the information processing apparatus 100A transmits a request to transmit a set {C′ₜ}:={C′₁, . . . , C′ₜ} of users who trust the user D to the information processing apparatus 100D.

In step S801, in response to receiving a request, each information processing apparatus 100B conceals the set {C_{i,j}}:={C_{i,1}, . . . , C_{i,si}} of users trusted by the user Bᵢ with a key bᵢ and generates a concealed set {E_{bi}(C_{i,j})}.

In step S802, each information processing apparatus 100Bᵢ transmits the generated set {E_{bi}(C_{i,j})} to the information processing apparatus 100A. Thereby, each information processing apparatus 100B may suppress leakage of the set {C_{i,j}}:={C_{i,1}, . . . , C_{i,si}} of users trusted by the user Bi corresponding to the information processing apparatus 100B.

In step S803, the information processing apparatus 100A generates a sum set {E_{B}(C)}:={{E_{b1}(C_{1,j})}, . . . , {E_{bn}(C_{n,j})}} of the set {E_{bi}(C_{i,j})} of users received from each information processing apparatus 100Bᵢ. The information processing apparatus A transmits the generated sum set {E_{B}(C)} to the information processing apparatus 100D.Thereby, the information processing apparatus 100A may hardly determine which element of the sum set {E_{B}(C)} is an element corresponding to any user A as a result of passing through the information processing apparatus 100D. The element is a concealed user ID.

In step S804, the information processing apparatus 100D conceals the sum set {E_{B}(C)} received from the information processing apparatus 100A with the key d, and generates the concealed sum set {E_{BD}(C)}: {{E_{b1,d}(C_{1,j})}, . . . , {E_{bn,d}(C_{n,j)}}.}

In step S805, the information processing apparatus 100D randomizes an order of elements included in the concealed sum set {E_{BD}(C)}:={{E_{b1,d}(C_{1,j})}, . . . , {E_{bn,d}(C_{n,j})}}.

In step S806, the information processing apparatus 100D transmits the concealed and randomized sum set {E_{BD}(C)} to the information processing apparatus 100A.

In step S807, in response to receiving a request, the Information processing apparatus 100D conceals a set {Ct}:={C′ₜ, . . . , C′ₜ} of users who trust the user D with the key d. Thereby, the information processing apparatus D generates a concealed set {E_{d}(C′ₜ)}:={E_{d}(C′₁), . . . , E_{d}(C′ₜ)}.

In step S808, the information processing apparatus 100D transmits the concealed set {E(C′ₜ)} to the information processing apparatus 100A. Thereby, the information processing apparatus 100D may hardly leak the set {C′ₜ}:={C′₁, . . . , C′ₜ} of users who trust the user D.

In step S809, the information processing apparatus 100A transmits the set {E_{d}(C′ₜ)} received from the Information processing apparatus 100D to each information processing apparatus 100Bᵢ.

In step S810, each information processing apparatus 100Bᵢ conceals the set {E_{d}(C′ₜ)} received from the information processing apparatus 100A with the key bᵢ and generates the concealed set {E_{d,bi}(C′ₜ)}:={E_{d,bi}(C′₁), . . . , E_{d,bi}(C′ₜ)}.

In step S811, each information processing apparatus 100Bᵢ transmits the concealed set {E_{d,bi}(C′ₜ)} to the information processing apparatus 100A.

In step S812, the information processing apparatus 100A generates a sum set {E_{DB}(C′)} of {E_{d,bi}(C′ₜ)}, . . . , {E_{d,bi}(C′ₜ)} received from each information processing apparatus 100Bᵢ. The information processing apparatus 100A compares the sum set {E_{DB}(C′)} with the sum set {E_{BD}(C)} and determines whether or not there is a common element. If there is a common element, the information processing apparatus 100A determines that the user A may trust the user D.

When a certain value X is concealed by a plurality of keys in consideration of a concealment method, results obtained by concealing the value X with the keys in a different order are the same as each other. For example, E_{bi,d}(X)=E_{d,bi}(X) is satisfied. Therefore, if the users A and D are connected to each other by a trust relationship through a second party, there is a set of ijk that satisfies C_{i,j}=C′ₖ. An element E_{bi,d}(C′) in a sum set {E_{DB}(C′)} and an element E_{d,bi}(C_{i,j}) in a sum set {E_{BD}(C)} have the same value and are common elements, and thus, there is a non-empty common set. Meanwhile, if the users A and D are not connected to each other by a trust relationship through a second party, there is no common set. As such, the information processing apparatus 100A may determine whether or not the users A and the user D are connected to each other by a trust relationship through a second party based on whether or not there is a common element.

Thereby, the information processing apparatus 100A may determine whether or not the user A may trust the user D while suppressing information leakage. For example, direct trust relationships of the respective users A, B, C, and D are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100A does not have to notify of identification information for identifying the information processing apparatus 100D when transmitting a request to the information processing apparatus 100B, the fact that the user A wants to determine whether or not the user D is trustable is not leaked.

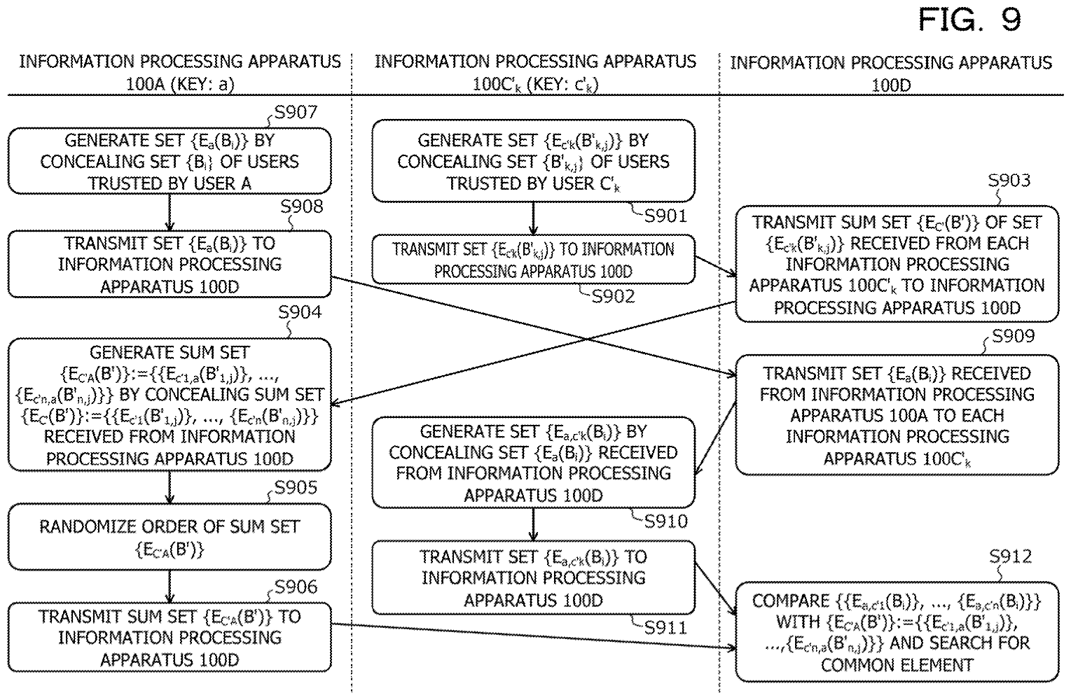

FIG. 9 is an explanatory diagram illustrating a second operation example of the information processing system 200. For example, FIG. 9 is a sequence diagram of the information processing system 200 that performs the second operation example.

In FIG. 9, at least, the information processing apparatus 100A generates a key a corresponding to the user A based on an operation input of the user A and conceals the key to retain. At least, an information processing apparatus 100Cₖ generates a key c′ₖ corresponding to a user C′ₖ based on an operation input of the user C′ₖ and conceals the key to retain. The user C′ₖ is a kth user C′ₖ included in a set {C′ₖ}:={C′₁, . . . , C′ₜ} of users directly trusted by the user D. k=1 to t. For example, the set of users is a set of user IDs.

The user A wants to determine whether or not the user D is trustable and performs an operation input to the information processing apparatus 100A. The information processing apparatus 100A transmits a request for determining whether or not the users A and D are indirectly connected to each other by a trust relationship to the information processing apparatus 100D based on an operation input of the user A. In response to receiving the request, the information processing apparatus 100D performs the same operation as the operation of the information processing apparatus 100A illustrated in FIG. 8.

For example, in the example of FIG. 9, the information processing apparatus 100A performs the same operation as the operation of the information processing apparatus 100D illustrated in FIG. 8, and the information processing apparatus 100D performs the same operation as the operation of the information processing apparatus 100A illustrated in FIG. 8. The information processing apparatus 100C′ₖ performs the same operation as the operation of the information processing apparatus 100B illustrated in FIG. 8. Therefore, processes of steps S901 to S912 are the same as the processes of steps S801 to S812 illustrated in FIG. 8. Accordingly, a specific description of the processes of steps S901 to S912 will be omitted.

The information processing apparatus 100D compares a sum set {E_{DB}(C′)} with a sum set {E_{BD}(C)}, and the information processing apparatus 100A receives a result of determining whether or not there is a common element. If there is a common element, the information processing apparatus 100A determines that the user A may trust the user D.

Thereby, the information processing apparatus 100A may determine whether or not the user A may trust the user D while suppressing information leakage. For example, direct trust relationships of the respective users A, B, C, and D are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100D does not have to notify of identification information for identifying the information processing apparatus 100A when transmitting a request to the information processing apparatus 100C′ₖ, the fact that the user A wants to determine whether or not the user D is trustable is not leaked.

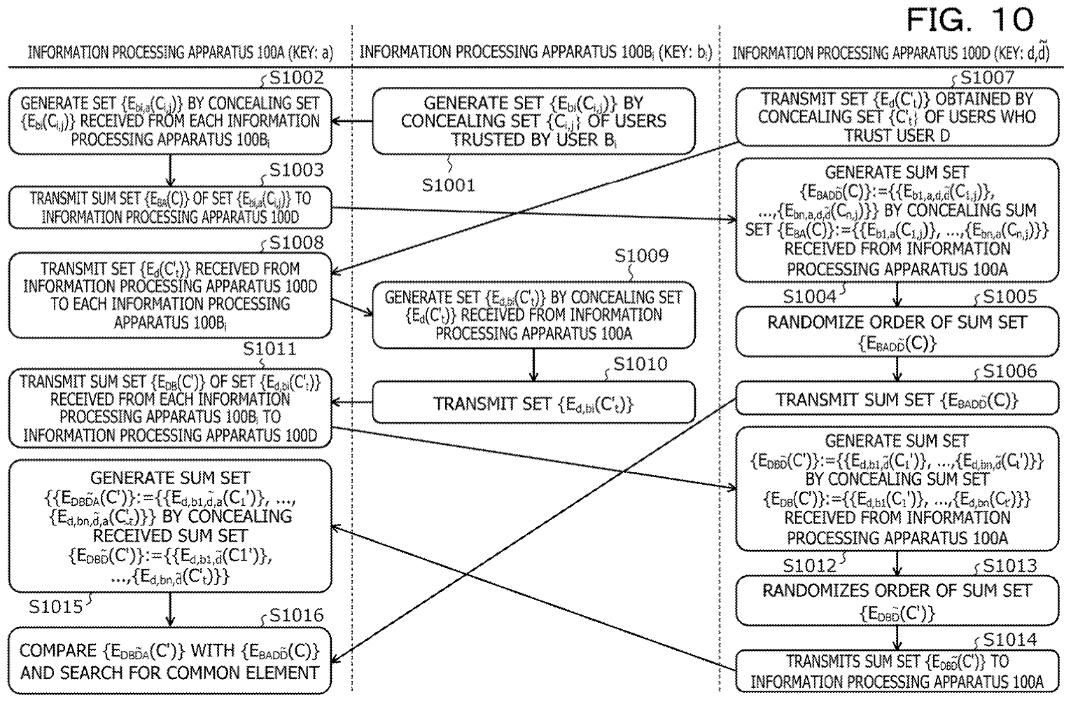

FIG. 10 is an explanatory diagram illustrating a third operation example of the information processing system 200. For example, FIG. 10 is a sequence diagram of the information processing system 200 that performs the third operation example. The third operation example corresponds to an improvement of the first operation example and may more easily suppress information leakage than in the first operation example.

In FIG. 10, at least, the information processing apparatus 100A generates a key a corresponding to the user A based on an operation input of the user A and conceals the key to retain. At least, the information processing apparatus 100Bᵢ generates a key bᵢ corresponding to the user Bᵢ based on an operation input of the user Bᵢ and conceals the key to retain. At least, the information processing apparatus 100D generates keys d and d˜ corresponding to the user D based on an operation input of the user D and conceals the keys to retain.

The user A wants to determine whether or not the user D is trustable and performs an operation input to the information processing apparatus 100A. The information processing apparatus 100A transmits various requests to each information processing apparatus 10B and the information processing apparatus 100D, based on the operation input of the user A. For example, the information processing apparatus 100A transmits a request to transmit a set {C_{i,j}}:={C_{i,1}, . . . , C_{i,si}} of users trusted by the user B to each information processing apparatus 100Bᵢ. For example, the information processing apparatus 100A transmits a request to transmit a set {C′ₜ}:={C′₁, . . . , C′ₜ} of users who trust the user D to the information processing apparatus 100D.

In step S1001, in response to receiving a request, each information processing apparatus 100Bᵢ conceals the set {C_{i,j}}:={C_{i,1}, . . . , C_{i,si}} of users trusted by the user B with the key b, and generates a concealed set {E_{bi}(C_{i,j})}. Each information processing apparatus 1000 transmits the generated set {E_{bi}(C_{i,j})} to the information processing apparatus 100A. Thereby, each information processing apparatus 100. may suppress leakage of the set {C_{i,j}}:={C_{i,1}, . . . , C_{i,si}} of users trusted by the user Bi corresponding to the information processing apparatus 100Bᵢ.

In step S1002, the information processing apparatus 100A conceals a set {E_{bi}(C_{i,j})} of the user received from each information processing apparatus 100B with the key a and generates the concealed set {E_{bi,a}(C_{i,j})}.

In step S1003, the information processing apparatus 100A generates a sum set {E_{BA}(C)}:={{E_{b1,a}(C_{1,j})}, . . . , {E_{bn,a}(C_{n,j})}} of the generated set {E_{bi,a}(C_{i,j})} and transmits the sum set to the information processing apparatus 100D. Thereby, the information processing apparatus 100A may hardly determine which element of the sum set {E_{BA}(C)} corresponds to any user Bᵢ as a result of passing through the information processing apparatus 100D.

In step S1004, the information processing apparatus 1001 conceals the sum set {E_{BA}(C)} received from the information processing apparatus 100A with keys d and d˜. Thereby, the information processing apparatus D generates the concealed sum set {E_{BADD}^{˜}(C)}:={{E_{b1,a,d,d}^{˜}(C^{1,j})}, . . . , {E_{bn,a,d,d}^{˜}(C_{n,j})}}.

In Step S1005, the information processing apparatus 100D randomizes an order of an element included in the concealed sum set {E_{BADD}^{˜}(C)}:={{E_{b1,a,d,d}^{˜}(C_{1,j})}, . . . , {E_{bn,a,d,d}^{˜}(C_{n,j})}}.

In step S1006, the information processing apparatus 100D transmits the concealed and randomized sum set {E_{BADD}^{˜}(C)} to the information processing apparatus 100A.

In step S1007, in response to receiving a request, the information processing apparatus 100D conceals a set {C′ₜ}:={C′₁, . . . , C′ₜ} of users who trust the user D with the key d. Thereby, the information processing apparatus D generates a concealed set {E_{d}(C′ₜ)}:={E_{d}(C′₁), . . . , E_{d}(C′ₜ)}. The information processing apparatus 100D transmits the concealed set {E_{d}(C′ₜ)} to the information processing apparatus 100A. Thereby, the information processing apparatus 100D may hardly leak the set {Ct}:={C′₁, . . . , C′ₜ} of users who trust the user D.

In step S1008, the information processing apparatus 100A transmits the set {E_{d}(C′ₜ)} received from the information processing apparatus 100D to each information processing apparatus 100R.

In step S1009, each information processing apparatus 1000, conceals the set {E_{d}(C′ₜ)} received from the information processing apparatus 100A with the key bᵢ and generates the concealed set {E_{d,bi}(C′ₜ)}:={E_{d,bi}(C′₁), . . . , E_{d,bi}(C′ₜ)}.

In step S1010, each information processing apparatus 100, transmits the concealed set {E_{d,bi}(C′ₜ)} to the information processing apparatus 100A.

In step S1011, the information processing apparatus 100A generates a sum set {E_{DB}(C)} of {E_{d,bi}(C′ₜ)}, . . . , {E_{d,bi}(C′ₜ)} received from each information processing apparatus 10B and transmits the sum set to the information processing apparatus 100D.

In step S1012, the information processing apparatus 100D conceals the sum set {E_{DB}(C′)} received from the information processing apparatus 100A with the key d and generates a concealed sum set {E_{DBD}^{˜}(C′)}.

In step S1013, the information processing apparatus 100D randomizes an order of elements included in the concealed sum set {E_{DBD}^{˜}(C)}.

In step S1014, the information processing apparatus 100D transmits the concealed and randomized sum set {E_{DBD}^{˜}(C′)} to the information processing apparatus 100A.

In step S1015, the information processing apparatus 100A conceals the sum set {E_{DBD}^{˜}(C′)} received from the information processing apparatus 100D with the key a and generates a concealed sum set {E_{DBD}^{˜}_{A}(C)}.

In step S1016, the information processing apparatus 100A compares the sum set {E_{DBD}^{˜}_{A}(C)} with the sum set {E_{BADD}^{˜}(C)} to determine whether or not there is a common element. If there is a common element, the information processing apparatus 100A determines that the user A may trust the user D.

Thereby, the information processing apparatus 100A may determine whether or not the user A may trust the user D while suppressing information leakage. For example, direct trust relationships of the respective users A, B, C, and D are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100A does not have to notify of identification information for identifying the information processing apparatus 100D when transmitting a request to the information processing apparatus 100Bᵢ, the fact that the user A wants to determine whether or not the user D is trustable is not leaked.

The information processing apparatus 100A may hardly determine which element of the sum set {E_{DB}(C′)} is an element received from the information processing apparatus 100M corresponding to any user B as a result of passing through the information processing apparatus 100D. Accordingly, the information processing apparatus 100A may hardly leak identification information for identifying other users trusted by the users B more and more.

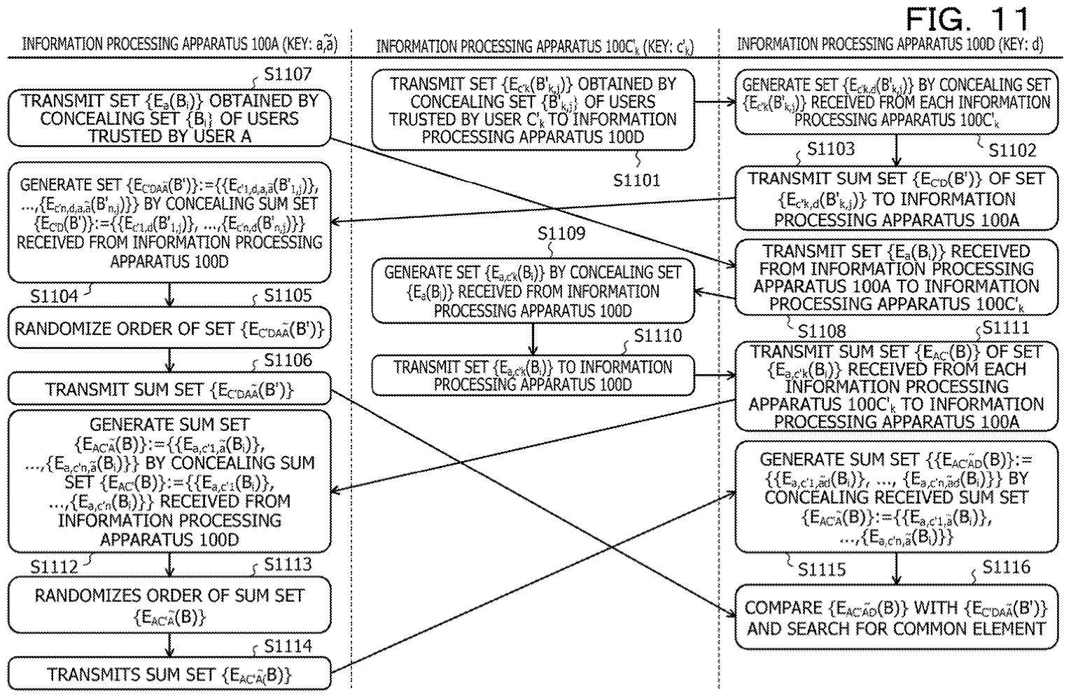

FIG. 11 is an explanatory diagram illustrating a fourth operation example of the information processing system 200. For example, FIG. 11 is a sequence diagram of the information processing system 200 that performs the fourth operation example. The fourth operation example corresponds to an improvement of the second operation example and may more easily suppress information leakage than in the first operation example.

In FIG. 11, at least, the information processing apparatus 100A generates keys a and a˜ corresponding to the user A based on an operation input of the user A and conceals the keys to retain. At least, an information processing apparatus 100C′ₖ generates a key c′ₖ corresponding to a user C′ₖ based on an operation input of the user C′ₖ and conceals the key to retain. At least, the information processing apparatus 100D generates a key d corresponding to the user D based on an operation input of the user D and conceals the key to retain.

The user A wants to determine whether or not the user D is trustable and performs an operation input to the information processing apparatus 100A. The information processing apparatus 100A transmits a request for determining whether or not the users A and D are indirectly connected to each other by a trust relationship to the information processing apparatus 100D based on an operation input of the user A. In response to receiving a request, the information processing apparatus 100D performs the same operation as the operation of the information processing apparatus 100A illustrated in FIG. 10.

For example, in the example of FIG. 11, the information processing apparatus 100A performs the same operation as the operation of the information processing apparatus 100D illustrated in FIG. 10, and the information processing apparatus 100D performs the same operation as the operation of the information processing apparatus 100A illustrated in FIG. 10. An information processing apparatus 100Cₖ performs the same operation as the operation of the information processing apparatus 100B illustrated in FIG. 10. Therefore, processes of steps S1101 to S1116 are the same as the processes of steps S1001 to S1016 illustrated in FIG. 10. Accordingly, a specific description of the processes of steps S1101 to S1116 will be omitted.

The information processing apparatus 100D compares the sum set {E_{DBD}^{˜}_{A}(′C)} with the sum set {E_{BADD}^{˜}(C)}, and the information processing apparatus 100A receive a result of determining whether or not there is a common element. If there is a common element, the information processing apparatus 100A determines that the user A may trust the user D.

Thereby, the information processing apparatus 100A may determine whether or not the user A may trust the user D while suppressing information leakage. For example, direct trust relationships of the respective users A, B, C, and D are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100D does not have to notify of identification information for identifying the information processing apparatus 100A when transmitting a request to the information processing apparatus 100C′ₖ, the fact that the user A wants to determine whether or not the user D is trustable is not leaked.

The information processing apparatus 100D may hardly determine which element of the sum set {E_{AC′}(Bᵢ)} is an element received from the information processing apparatus C′ₖ corresponding to any user C′ₖ as a result of passing through the information processing apparatus 100A. Accordingly, the information processing apparatus 100A may further suppress leakage of identification information for identifying other users trusted by the user Ck.

In the first to fourth examples, a case in which the respective information processing apparatuses 100 directly exchange information is described, but the examples are not limited thereto. For example, the information processing apparatuses 100 may use some anonymous communication system. The anonymous communication system is realized by, for example, a blockchain. According to the anonymous communication system, when the information processing apparatus 100A transmits a set X to the information processing apparatus 100B, transaction is recorded as not being falsified, and details of the transaction are concealed although the transaction is shared by the respective information processing apparatuses 100. The details include, for example, a transmitter, a receiver, content of the transmitted set, and the like.

(Fifth to Eighth Operation Examples of Information Processing System 200)

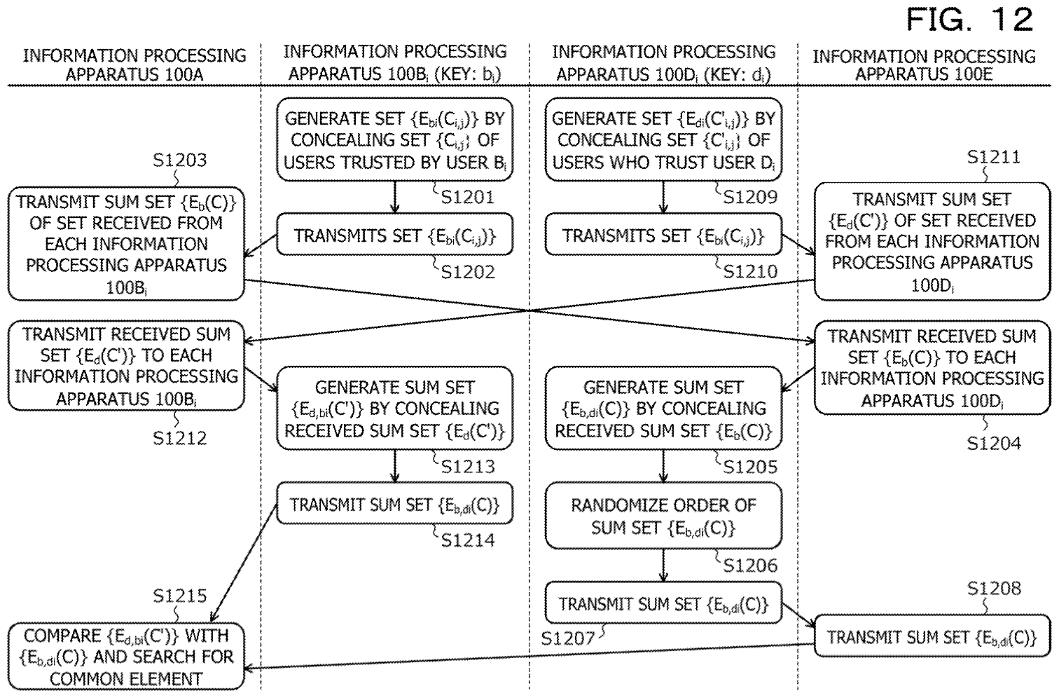

Next, fifth to eighth operation examples of the information processing system 200 will be described with reference to FIGS. 12 to 15. Each of the above-described first to fourth operation examples corresponds to a case in which the information processing apparatus 100 determines whether or not a first user and a second user are indirectly connected to each other by a trust relationship through a second party. In contrast to this, each of the fifth to eighth operation examples corresponds to a case in which the information processing apparatus 100 determines whether or not the first user and the second user are indirectly connected to each other by a trust relationship through a third party.

FIG. 12 is an explanatory diagram illustrating the fifth operation example of the information processing system 200. For example, FIG. 12 is a sequence diagram of the information processing system 200 that performs the fifth operation example.

In FIG. 12, at least, the information processing apparatus 100B generates the key bi corresponding to the user B based on an operation input of the user Bᵢ and conceals the key to retain. The user B is an ith user B included in a set {Bᵢ}:={B₁, . . . , Bₙ} of users directly trusted by the user A. i=1 to n. For example, the set of users is a set of user IDs. At least, the information processing apparatus 100D generates a key dᵢ corresponding to a user Dᵢ based on an operation input of the user Dᵢ, and conceals the key to retain. The user Dᵢ is an ith user Dᵢ included in a set {Dᵢ}:={D₁, . . . , Dₘ} of users directly trusted by the user E. i=1 to m.

The user A wants to determine whether or not the user E is trustable and performs an operation input to the information processing apparatus 100A. The information processing apparatus 100A transmits various requests to each information processing apparatus 100B and the information processing apparatus 100E, based on the operation input of the user A. For example, the information processing apparatus 100A transmits a request to transmit a set {C_{i,j}}:={C_{i,1}, . . . , C_{i,si}} of users trusted by the user Bᵢ to each information processing apparatus 100Bᵢ.

For example, the information processing apparatus 100A transmits a request to transmit a set {C′_{i,j}}:={C′_{i,1}, . . . , C′_{i,si}} of users who trust each user D which trusts the user E to the information processing apparatus 100E. In response to receiving a request, the information processing apparatus 100E transmits a request a request to transmit the set {C′_{i,j}}:={C′_{i,1}, . . . , C′_{i,si}} of users to that trusts the user Dᵢ to the information processing apparatus 100Dᵢ.

The information processing apparatus 100A does not directly transmit a request to transmit a set {C′_{i,j}}:={C′_{i,1}, . . . , C′_{i,si}} of users who trust the user Di to the information processing apparatus 100Dᵢ and transmits the request through the information processing apparatus 100E. Accordingly, the information processing apparatus 100A may conceal which of the users Dᵢ is trusted by the user E.

In step S1201, in response to receiving a request, each information processing apparatus 100Bᵢ conceals the set {C_{i,j}}:={C_{i,1}, . . . , C_{i,si}} of users trusted by the user Bᵢ with the key bᵢ and generates a concealed set {E_{bi}(C^{i,j})}.

In step S1202, each information processing apparatus 100Bᵢ transmits the generated set {E_{bi}(C_{i,j})} to the information processing apparatus 100A. Thereby, each information processing apparatus 100Bᵢ may suppress leakage of the set {C_{i,j}}:={C_{i,1}, . . . , C_{i,si}} of users trusted by the user Bi corresponding to the information processing apparatus 100Bᵢ.

In step S1203, the information processing apparatus 100A generates a sum set {E_{b}(C)}:={{E_{b1}(C_{1,j})}, . . . , {E_{bn}(C_{n,j})}} of the set {E_{bi}(C_{i,j})} of users received from each information processing apparatus 100Bᵢ. The information processing apparatus A transmits the generated sum set {E_{b}(C)} to the information processing apparatus 100E. Thereby, the information processing apparatus 100A may hardly determine which element of the sum set {E_{b}(C)} is an element corresponding to any user Bᵢ as a result of passing through the information processing apparatus 100E. The element is a concealed user ID.

In step S1204, the information processing apparatus 100E transmits the sum set {E_{b}(C)} received from the information processing apparatus 100A to each information processing apparatus 100Dᵢ.

In step S1205, each information processing apparatus 100Dᵢ conceals the sum set {E_{b}(C)} received from the information processing apparatus 100E with a key dᵢ. Thereby, each information processing apparatus 100Dᵢ. generates a concealed sum set {E_{b,di}(C)}:={{E_{b1,di}(C_{1,j})}, . . . , {E^{bn,di}(C_{n,j})}.

In step S1206, each information processing apparatus 100Dᵢ randomizes an order of elements included in the concealed sum set {E_{b,di}(C)}:={{E_{b1,di}(C_{1,j})}, . . . , {E_{bn,di}(C_{n,j})}}.

In step S1207, each information processing apparatus 100Dᵢ transmits the concealed and randomized sum set {E_{b,di}(C)} to the information processing apparatus 100E.

In step S1208, the information processing apparatus 100E transmits the sum set {E_{b,di}(C)} received from the information processing apparatus 100Dᵢ to the information processing apparatus 100A.

In step S1209, in response to receiving a request, each information processing apparatus 100Dᵢ conceals a set {C′_{i,j}}:=C′_{i,1}, . . . , C′_{i,si}} of users who trust the user Dᵢ with the key dᵢ. Thereby, each information processing apparatus 100Dᵢ generates a concealed set {E_{di}(C′_{i,j})}:={E_{di}(C′_{i,1}), . . . , E_{di}(C′_{i,si})}.

In step S1210, each information processing apparatus 100Dᵢ transmits the concealed set {E_{di}(C′_{i,j})} to the information processing apparatus 100E. Thereby, each information processing apparatus 100Dᵢ may suppress leakage of the set {C′_{i,j}}:={C′_{i,1}, . . . , C′_{i,si}} of users who trust the user Dᵢ.

In step S1211, the information processing apparatus 100E generates a sum set {E_{d}(C′)} of the set {E_{di}(C′_{i,j})} received from each information processing apparatus 100D, and transmits the sum set to the information processing apparatus 100A.

In step S1212, the information processing apparatus 100A transmits the sum set {E_{d}(C′)} received from the information processing apparatus 100E to each information processing apparatus 1008.

In step S1213, each information processing apparatus 100Bᵢ conceals the sum set {E_{d}(C′)} received from the information processing apparatus 100A with the key b and generates the concealed sum set {E_{d,bi}(C′)}.

In step S1214, each information processing apparatus 100B transmits the concealed sum set {E_{d,bi}(C′)} to the information processing apparatus 100A.

In step S1215, the information processing apparatus 100A determines whether or not there is a common element in the sum set {E_{d,bi}(C′)} received from each information processing apparatus 100B and the sum set {E_{b,di}(C)} received from the information processing apparatus 100E. If there is a common element, the information processing apparatus 100A determines that the user A may trust the user E.

Thereby, the information processing apparatus 100A may determine whether or not the user A may trust the user E while suppressing information leakage. For example, the direct trust relationships of the users A to E are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100A does not have to notify of identification information for identifying the information processing apparatus 100E when transmitting a request to the information processing apparatus 1008, the fact that the user A wants to determine whether or not the user E is trustable is not leaked.

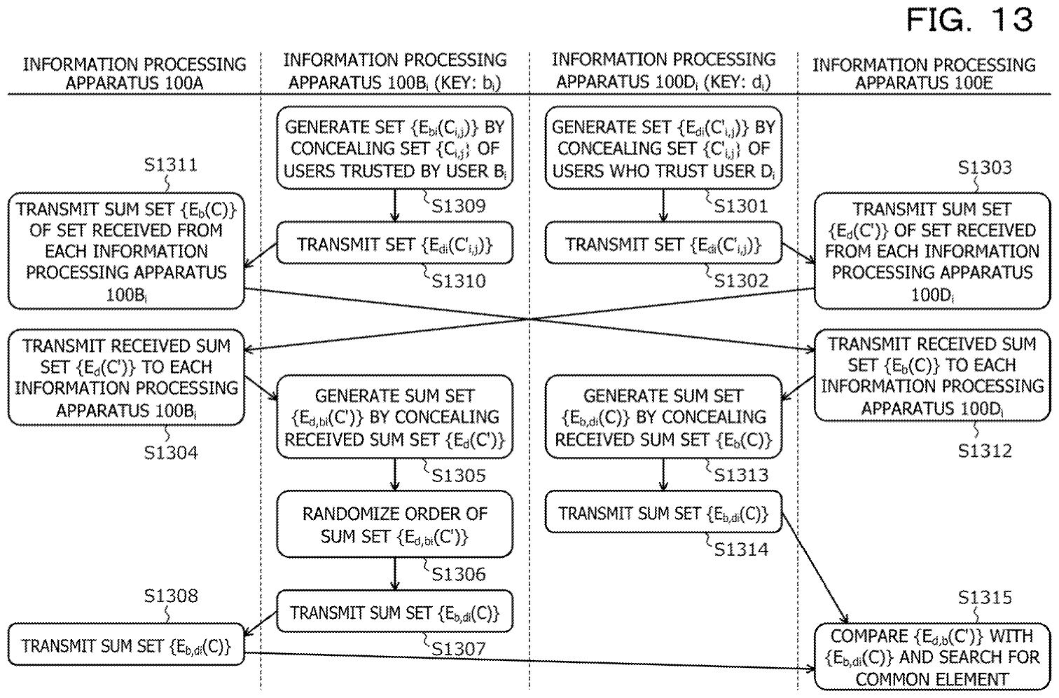

FIG. 13 is an explanatory diagram illustrating the sixth operation example of the information processing system 200. For example, FIG. 13 is a sequence diagram of the information processing system 200 that performs the sixth operation example.

In FIG. 13, at least, the information processing apparatus 100, generates the key bᵢ corresponding to the user Bᵢ based on an operation input of the user Bᵢ, and conceals the key to retain. At least, the information processing apparatus 100Dᵢ generates a key dᵢ corresponding to a user Dᵢ based on an operation input of the user Dᵢ, and conceals the key to retain.

The user A wants to determine whether or not the user D is trustable and performs an operation input to the information processing apparatus 100A. The information processing apparatus 100A transmits a request to determine whether or not the user A and the user E are indirectly connected to each other by a trust relationship to the information processing apparatus 100E based on an operation input of the user A. In response to receiving a request, the information processing apparatus 100E performs the same operation as the operation of the information processing apparatus 100A illustrated in FIG. 12.

For example, in the example of FIG. 13, the information processing apparatus 100A performs the same operation as the operation of the information processing apparatus 100E illustrated in FIG. 12, and the information processing apparatus 100E performs the same operation as the operation of the information processing apparatus 100A illustrated in FIG. 12. The information processing apparatus 100Bᵢ performs the same operation as the operation of the information processing apparatus 100Dᵢ illustrated in FIG. 12, and the information processing apparatus 100Dᵢ performs the same operation as the operation of the information processing apparatus 10B illustrated in FIG. 12. Therefore, processes of steps S1301 to S1315 are the same as the processes of steps S1201 to S1215 illustrated in FIG. 12. Accordingly, a specific description of the processes of steps S1301 to S1315 will be omitted.

The information processing apparatus 100E compares the sum set {E_{d,bi}(C′)} with the sum set {E_{b,di}(C)} and the information processing apparatus 100A receives a result of determining whether or not there is a common element. If there is a common element, the information processing apparatus 100A determines that the user A may trust the user E.

Thereby, the information processing apparatus 100A may determine whether or not the user A may trust the user E while suppressing information leakage. For example, the direct trust relationships of the users A to E are not leaked to each other.

For example, each information processing apparatus 100 conceal user IEs with keys corresponding to the information processing apparatus and an order of the concealed user IEs is randomized as appropriate, and thus, direct trust relationships of the respective users are not leaked. Since the information processing apparatus 100E does not have to notify of identification information for identifying the information processing apparatus 100A when transmitting a request to the information processing apparatus 100C′ₖ, the fact that the user A wants to determine whether or not the user E is trustable is not leaked.

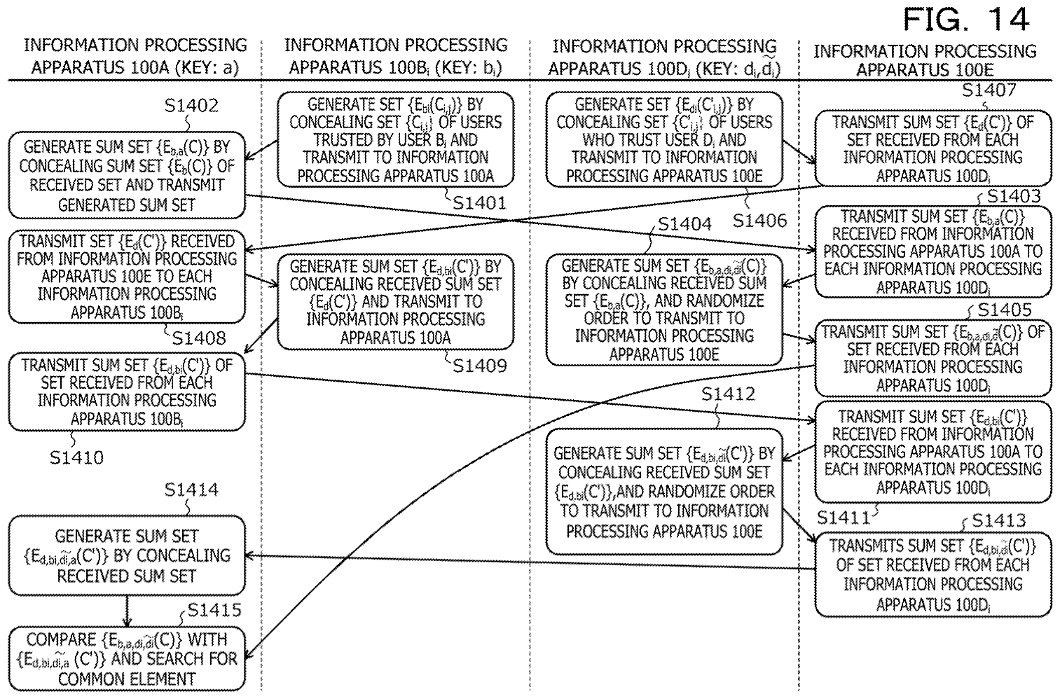

FIG. 14 is an explanatory diagram illustrating the seventh operation example of the information processing system 200. For example, FIG. 14 is a sequence diagram of the information processing system 200 that performs the seventh operation example. The seventh operation example corresponds to an improvement of the fifth operation example and may more easily suppress information leakage than in the fifth operation example.

In FIG. 14, at least, the information processing apparatus 100A generates the key a corresponding to the user A based on an operation input of the user A and conceals the key to retain. At least, the information processing apparatus 100Bᵢ generates a key b, corresponding to the user B, based on an operation input of the user B; and conceals the key to retain. At least, the information processing apparatus 100D generates keys dᵢ and dᵢ˜ corresponding to the user Dᵢ based on an operation input of the user Dᵢ and conceals the keys to retain.

The user A wants to determine whether or not the user E is trustable and performs an operation input to the information processing apparatus 100A. The information processing apparatus 100A transmits various requests to each information processing apparatus 10B and the information processing apparatus 100E, based on the operation input of the user A. For example, the information processing apparatus 100A transmits a request to transmit a set {C_{i,j}}:={C_{i,1}, . . . , C_{i,si}} of users trusted by the user Bᵢ to each information processing apparatus 100Bᵢ.

For example, the information processing apparatus 100A transmits a request to transmit a set {C′_{i,j}}:={C′_{i,1}, . . . , C′_{i,si}} of users who trust each user Dᵢ which trusts the user E to the information processing apparatus 100E. In response to receiving a request, the information processing apparatus 100E transmits a request a request to transmit the set {C′_{i,j}}:={C′_{i,1}, . . . , C′_{i,si}} of users to that trusts the user Dᵢ to the information processing apparatus 100Dᵢ.

The information processing apparatus 100A does not directly transmit a request to transmit a set {C′_{i,j}}:={C′_{i,1}, . . . , C′_{i,si}} of users who trust the user Dᵢ to the information processing apparatus 100Dᵢ and transmits the request through the information processing apparatus 100E. Accordingly, the information processing apparatus 100A may conceal which of the users Dᵢ is trusted by the user E.

In step S1401, in response to receiving a request, each information processing apparatus 100B conceals the set {C_{i,j}}:={C_{i,1}, . . . , C_{i,si}} of users trusted by the user B with the key bi and generates a concealed set {E_{bi}(C_{i,j})}. Each information processing apparatus 100B transmits the generated set {E_{bi}(C_{i,j})} to the information processing apparatus 100A. Thereby, each information processing apparatus 100Bᵢ may suppress leakage of the set {C_{i,j}}:={C_{i,1}, . . . , C_{i,si}} of users trusted by the user Bi corresponding to the information processing apparatus 100B.

In step S1402, the information processing apparatus 100A generates a sum set {E_{b}(C)}:={{E_{b1}(C_{1,j})}, . . . , {E_{bn}(C_{n,j})}} of a set {E_{bi}(C_{i,j})} of users received from each information processing apparatus 100Bᵢ, and conceals the generated sum set with the key a. The information processing apparatus 100A transmits the concealed sum set {E_{b,a}(C)} to the information processing apparatus 100E. Thereby, the information processing apparatus 100A may hardly determine which element of the sum set {E_{b,a}(C)} is an element corresponding to any user Bᵢ as a result of passing through the information processing apparatus 100E.

In step S1403, the information processing apparatus 100E transmits the sum set {E_{b,a}(C)} received from the information processing apparatus 100A to each information processing apparatus 100Dᵢ.

In step S1404, each information processing apparatus 100Dᵢ conceals the sum set {E_{b,a}(C)} received from the information processing apparatus 100E with keys dᵢ and dᵢ˜ to generate a concealed sum set {E^{b,a,di,di}˜(C)}. Each information processing apparatus 100Dᵢ randomizes an order of elements included in the concealed sum set {E_{b,a,di,di}˜(C)}. Each information processing apparatus 100D, transmits the concealed and randomized sum set {E_{b,a,di,di}˜(C)} to the information processing apparatus 100E.

In step S1405, the information processing apparatus 100E transmits the sum set {E_{b,a,di,di}˜(C)} received from the information processing apparatus 100Dᵢ to the information processing apparatus 100A.

In step S1406, in response to receiving a request, each information processing apparatus 100Dᵢ conceals the set {C′_{i,j}}:={C′_{i,1}, . . . , C′_{i,si}} of users who trust the user Dᵢ with the key dᵢ, and generate the concealed set {E_{di}(C′_{i,j})}. Each information processing apparatus 100Dᵢ transmits the concealed set {E_{di}(C′_{i,j})} to the information processing apparatus 100E. Thereby, the information processing apparatus 100Dᵢ may suppress leakage of the set {C_{i,j}}:={C_{i,1}, . . . , C′_{i,si}} of users who trust the user Dᵢ.

In step S1407, the information processing apparatus 100E generates a sum set {E_{d}(C′)} of the set {E_{di}(C′_{i,j})} received from each information processing apparatus 100Dᵢ and transmits the generated sum set to the information processing apparatus 100A.

In step S1408, the information processing apparatus 100A transmits the sum set {E_{d}(C′)} received from the information processing apparatus 100E to each information processing apparatus 100Bᵢ.

In step S1409, each information processing apparatus 100Bᵢ conceals the sum set {E_{d}(C′)} received from the information processing apparatus 100A with the key bᵢ and generates the concealed set {E_{d,bi}(C′)}. Each information processing apparatus 100Bᵢ transmits the concealed sum set {E_{d,bi}(C)} to the information processing apparatus 100A.

In step S1410, the information processing apparatus 100A transmits the concealed sum set {E_{d,bi}(C)} received from each information processing apparatus 100Bᵢ to the information processing apparatus 100E.

In step S1411, the information processing apparatus 100E transmits the concealed sum set {E_{d,bi}(C)} received from the information processing apparatus 100A to each information processing apparatus 100Dᵢ.

In step S1412, each information processing apparatus 100Dᵢ conceals the sum set {E_{d,bi}(C)} received from the information processing apparatus 100E with the key dᵢ˜, and generates the concealed sum set {E_{d,bi,di}˜(C′)}. Each information processing apparatus 100Dᵢ randomizes an order of elements included in the concealed sum set {E_{d,bi,di}˜(C′)}. Each information processing apparatus 100D; transmits the concealed and randomized sum set {E_{d,bi,di}˜(C)} to the information processing apparatus 100E.

In step S1413, the information processing apparatus 100E transmits the sum set {E_{d,bi,di}˜(C)} received from information processing apparatus 100D; to the information processing apparatus 100A.

In step S1414, the information processing apparatus 100A conceals the sum set {E_{d,bi,di}˜(C′)} received from the information processing apparatus 100E with the key a, and generates a concealed sum set {E_{d,bi,di}˜_{,a}(C′)}.

In step S1415, the information processing apparatus 100A determines whether or not there is a common element in the sum set {E_{d,bi,di}˜(C)} and the sum set {E_{d,bi,di}˜_{,a}(C′)}. If there is a common element, the information processing apparatus 100A determines that the user A may trust the user E.

Thereby, the information processing apparatus 100A may determine whether or not the user A may trust the user E while suppressing information leakage. For example, the direct trust relationships of the users A to E are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100A does not have to notify of identification information for identifying the information processing apparatus 100E when transmitting a request to the information processing apparatus 100Bᵢ, the fact that the user A wants to determine whether or not the user E is trustable is not leaked.

The information processing apparatus 100A may hardly determine whether or not the sum set {E_{d,bi}(C)} is received from the information processing apparatus 100; corresponding to any user Bᵢ, as a result of passing through the information processing apparatus 100E. Accordingly, the information processing apparatus 100A may hardly leak identification information for identifying other users trusted by the users B more and more.

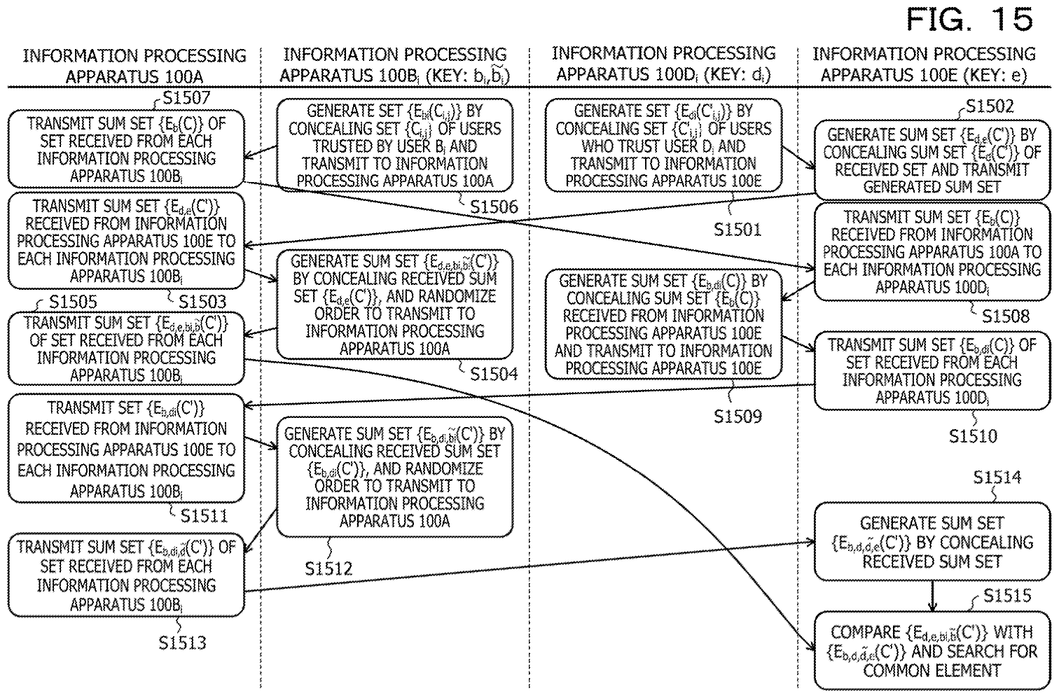

FIG. 15 is an explanatory diagram illustrating an eighth operation example of an information processing system. For example, FIG. 15 is a sequence diagram of the information processing system 200 that performs the eighth operation example. The eighth operation example corresponds to an improvement of the sixth operation example and may more easily suppress information leakage than in the sixth operation example.

In FIG. 15, at least, the information processing apparatus 100Bᵢ generates the keys bᵢ and bᵢ˜ corresponding to the user Bᵢ based on an operation input of the user Bᵢ and conceals the keys to retain. At least, the information processing apparatus 100Dᵢ generates a key dᵢ corresponding to a user Dᵢ based on an operation input of the user Dᵢ, and conceals the key to retain. At least, the information processing apparatus 100E generates a key e corresponding to the user E based on an operation input of the user E and conceals the key to retain.

The user A wants to determine whether or not the user D is trustable and performs an operation input to the information processing apparatus 100A. The information processing apparatus 100A transmits a request to determine whether or not the user A and the user E are indirectly connected to each other by a trust relationship to the information processing apparatus 100E based on an operation input of the user A. In response to receiving a request, the information processing apparatus 100E performs the same operation as the operation of the operation of the information processing apparatus 100A illustrated in FIG. 14.

For example, in the example of FIG. 15, the information processing apparatus 100A performs the same operation as the operation of the information processing apparatus 100E illustrated in FIG. 14, and the information processing apparatus 100E performs the same operation as the operation of the information processing apparatus 100A illustrated in FIG. 14. The information processing apparatus 100Bᵢ performs the same operation as the operation of the information processing apparatus 100Dᵢ illustrated in FIG. 14, and the information processing apparatus 100Dᵢ performs the same operation as the operation of the information processing apparatus 100Bᵢ illustrated in FIG. 14. Therefore, processes of steps S1501 to S1515 are the same as the processes of steps S1401 to S1415 illustrated in FIG. 14. Accordingly, a specific description of the processes of steps S1501 to S1515 will be omitted.

The information processing apparatus 100E compares the sum set {E_{d,bi,di}˜(C)} with the sum set {E_{d,bi,di}˜_{,a}(C′)}, and the information processing apparatus 100A receives a result of determining whether or not there is a common element. If there is a common element, the information processing apparatus 100A determines that the user A may trust the user E.

Thereby, the information processing apparatus 100A may determine whether or not the user A may trust the user E while suppressing information leakage. For example, the direct trust relationships of the users A to E are not leaked to each other.

For example, each information processing apparatus 100 conceal user IDs with keys corresponding to the information processing apparatus, an order of the concealed user IDs is randomized as appropriate, and thus, direct trust relationships of the respective users are not leaked. Since the information processing apparatus 100A does not have to notify of identification information for identifying the information processing apparatus 100E when transmitting a request to the information processing apparatus 100Bᵢ, the fact that the user A wants to determine whether or not the user E is trustable is not leaked.

The information processing apparatus 100E may hardly determine whether or not the sum set {E_{b,di}(C)} is received from the information processing apparatus 100Dᵢ corresponding to any users Dᵢ, as a result of passing through the information processing apparatus 100A. Accordingly, the information processing apparatus 100E may further suppress leakage of identification information for identifying other users trusted by the users Dᵢ.

For the sake of convenient description, process orders of the respective steps in the respective sequence diagrams illustrated in FIGS. 8 to 15 are described in the orders described above, and embodiments are not limited thereto. For example, the process orders of the respective steps in the respective sequence diagrams may not be the orders described above. For example, the processes of steps S801 to S806 may be performed after the processes of steps S807 to S811 are performed. For example, the processes of steps S801 to S806 and the processes of steps S807 to S811 may be performed in parallel.

As described above, according a first information processing apparatus 100, it is possible to acquire, from a second information processing apparatus 100, first aggregated information in which identification information for identifying each user having a specific relationship with each user having a specific relationship with a first user is summarized. According to the first information processing apparatus 100, it is possible to acquire, from the second information processing apparatus 100, second aggregated information in which identification information for Identifying each user having a specific relationship with a second user is summarized. According to the first information processing apparatus 100, it is possible to determine whether or not the first user and the second user have a specific relationship based on the acquired first aggregated information and the acquired second aggregated information. Thereby, when determining whether or not the first user and the second user have a specific relationship, the first information processing apparatus 100 may easily conceal information indicating that the users have a specific relationship.

According to the first information processing apparatus 100, it is possible to acquire the first aggregated information encoded by the second information processing apparatus 100. Thereby, the first information processing apparatus 100 may suppress leakage of the fact that an element of the first aggregated information is an element corresponding to any user having a specific relationship with the first user.

According to the first information processing apparatus 100, it is possible for the second information processing apparatus 100 to acquire the first aggregated information in which an order of identification information for identifying each user having a specific relationship with each user having a specific relationship with the first user is randomized and summarized. Thereby, the first information processing apparatus 100 may suppress leakage of the fact that an element of the first aggregated information is an element corresponding to any user having a specific relationship with the first user.

According to the first information processing apparatus 100, it is possible to transmit identification information for identifying each user having a specific relationship with each user having a specific relationship with the first user to the second information processing apparatus 100. According to the first information processing apparatus 100, it is possible to acquire the first aggregated information in which the transmitted identification information is summarized, from the second information processing apparatus 100. Thereby, the first information processing apparatus 100 may not notify the second information processing apparatus 100 of an apparatus corresponding to each user having a specific relationship with the first user, and suppress information leakage.

According to the first information processing apparatus 100, it is possible to acquire identification information, which is encoded by the information processing apparatus 100 corresponding to each user having a specific relationship with the first user, for identifying each user having a specific relationship with the users. According to the first information processing apparatus 100, it is possible to transmit the acquired identification information to the second information processing apparatus 100. According to the first information processing apparatus 100, it is possible to acquire the first aggregated information in which the transmitted identification information is summarized, from the second information processing apparatus 100. Thereby, the first information processing apparatus 100 may acquire the first aggregated information that is processed to suppress leakage of the identification information.

According to the first information processing apparatus 100, it is possible to transmit identification information for identifying each user having a specific relationship with each user having a specific relationship with the first user to the second information processing apparatus 100 after being encoded by the first information processing apparatus 100. According to the first information processing apparatus 100, it is possible to acquire, from the second information processing apparatus 100, the first aggregated information in which the identification information encoded and transmitted by the first information processing apparatus 100 is summarized. Thereby, the first information processing apparatus 100 may suppress leakage of identification information.

According to the first information processing apparatus 100, it is possible to acquire the second aggregated information encoded by the second information processing apparatus 100. Thereby, the first information processing apparatus 100 may acquire the second aggregated information processed to suppress information leakage.

According to the first information processing apparatus 100, it is possible to transmit the acquired second aggregated information to the information processing apparatus 100 corresponding to each user having a specific relationship with the first user. According to the first information processing apparatus 100, it is possible to receive the transmitted second aggregated information encoded by the information processing apparatus 100 corresponding to each user having a specific relationship with the first user. According to the first information processing apparatus 100, it is possible to generate third aggregated information in which the received second aggregated information is summarized. According to the first information processing apparatus 100, it is possible to determine whether or not the first user and the second user have a specific relationship based on the first aggregated information and the generated third aggregated information. Thereby, the first information processing apparatus 100 may acquire the second aggregated information processed to suppress information leakage.

According to the first information processing apparatus 100, it is possible to transmit the generated third aggregated information to the second information processing apparatus 100. According to the first information processing apparatus 100, it is possible to receive, from the second information processing apparatus 100, the transmitted third aggregated information encoded by the second information processing apparatus 100. According to the first information processing apparatus 100, it is possible to determine whether or not the first user and the second user have a specific relationship based on the first aggregated information and the received third aggregated information encoded by the second information processing apparatus 100. Thereby, the first information processing apparatus 100 may acquire the second aggregated information processed to suppress information leakage.

According to the first information processing apparatus 100, it is possible to transmit the generated third aggregated information to the second information processing apparatus 100. According to the first information processing apparatus 100, it is possible to receive, from the second information processing apparatus 100, the transmitted third aggregated information in which an order of the second aggregated information is randomized and resummarized by the second information processing apparatus 100. According to the first information processing apparatus 100, it is possible to determine whether or not the first user and the second user have a specific relationship based on the first aggregated information and the third aggregated information in which an order of the second aggregated information is randomized and resummarized. Thereby, the first information processing apparatus 100 may hardly determine whether or not the second aggregated information is encoded by the information processing apparatus 100 corresponding to any user. Accordingly, the first information processing apparatus 100 may suppress information leakage.

According to the first information processing apparatus 100, it is possible to determine whether or not the first user and the third user have a specific relationship based on the first aggregated information and the second aggregated information encoded by the first information processing apparatus 100. Thereby, the first information processing apparatus 100 may suppress information leakage.

According to the first information processing apparatus 100, it is possible to determine whether or not the first user and the second user are indirectly connected to each other by a specific relationship through a second party. Thereby, the first information processing apparatus 100 may be applied to when the first user and the second user are indirectly connected to each other by a specific relationship through the second party.

According to the first information processing apparatus 100, it is possible to acquire, from the second information processing apparatus 100, the first aggregated information in which identification information for identifying each user having a specific relationship with each user having a specific relationship with the first user is summarized. According to the first Information processing apparatus 100, it is possible to acquire, from the second information processing apparatus 100, the second aggregated information in which identification information for identifying each user having a specific relationship with each user having a specific relationship with the second user is summarized. According to the first information processing apparatus 100, it is possible to determine whether or not the first user and the second user have a specific relationship based on the acquired first aggregated information and the acquired second aggregated information. Thereby, when determining whether or not the first user and the second user have a specific relationship, the first information processing apparatus 100 may easily conceal information indicating that the users have a specific relationship.

According to the first information processing apparatus 100, it is possible to acquire, from the second information processing apparatus 100, the first aggregated information encoded by the information processing apparatus 100 corresponding to each user having a specific relationship with the second user. Thereby, the first information processing apparatus 100 may suppress leakage of the fact that an element of the first aggregated information is an element corresponding to any user having a specific relationship with the first user.

According to the first information processing apparatus 100, it is possible to acquire, from the second information processing apparatus 100, the first aggregated information in which an order of identification information is randomized and resummarized by the information processing apparatus 100 corresponding to each user having a specific relationship with the second user. Thereby, the first information processing apparatus 100 may suppress leakage of the fact that an element of the first aggregated information is an element corresponding to any user having a specific relationship with the first user.

According to the first information processing apparatus 100, it is possible to acquire identification information for Identifying each user having a specific relationship with the users from the information processing apparatus 100 corresponding to each user having a specific relationship with the first user, and to transmit the identification information to the second information processing apparatus 100. According to the first information processing apparatus 100, it is possible to acquire the first aggregated information in which the transmitted identification information is summarized, from the second information processing apparatus 100. Thereby, the first information processing apparatus 100 may not notify the second information processing apparatus 100 of an apparatus corresponding to each user having a specific relationship with the first user, and suppress information leakage.

According to the first information processing apparatus 100, it is possible to acquire identification information, which is encoded by the information processing apparatus 100 corresponding to each user having a specific relationship with the first user, for identifying each user having a specific relationship with the users. According to the first information processing apparatus 100, it is possible to transmit the acquired identification information to the second information processing apparatus 100. According to the first information processing apparatus 100, it is possible to acquire the first aggregated information in which the transmitted identification information is summarized, from the second information processing apparatus 100. Thereby, the first information processing apparatus 100 may acquire the first aggregated information that is processed to suppress leakage of the identification information.

According to the first information processing apparatus 100, it is possible to transmit identification information for identifying each user having a specific relationship with each user having a specific relationship with the first user to the second information processing apparatus 100 after being encoded by the first information processing apparatus 100. According to the first information processing apparatus 100, it is possible to acquire, from the second information processing apparatus 100, the first aggregated information in which the identification information encoded and transmitted by the first information processing apparatus 100 is summarized. Thereby, the first information processing apparatus 100 may suppress leakage of identification information.

According to the first information processing apparatus 100, it is possible to acquire the second aggregated information encoded by the information processing apparatus 100 corresponding to each user having a specific relationship with the second user. Thereby, the first information processing apparatus 100 may acquire the second aggregated information processed to suppress information leakage.

According to the first information processing apparatus 100, it is possible to transmit the acquired second aggregated Information to the information processing apparatus 100 corresponding to each user having a specific relationship with the first user. According to the first information processing apparatus 100, it is possible to receive the transmitted second aggregated information encoded by the information processing apparatus 100 corresponding to each user having a specific relationship with the first user. According to the first information processing apparatus 100, it is possible to generate fourth aggregated information in which the received second aggregated information is summarized. According to the first information processing apparatus 100, it is possible to determine whether or not the first user and the second user have a specific relationship based on the first aggregated information and the generated fourth aggregated information. Thereby, the first information processing apparatus 100 may acquire the second aggregated information processed to suppress information leakage.

According to the first information processing apparatus 100, it is possible to transmit the generated fourth aggregated information to the second information processing apparatus 100. According to the first information processing apparatus 100, it is possible to receive, from the second information processing apparatus 100, the fourth aggregated information encoded by the information processing apparatus 100 corresponding to each user having a specific relationship with the second user through the second information processing apparatus 100. According to the first information processing apparatus 100, it is possible to determine whether or not the first user and the second user have a specific relationship based on the first aggregated information and the encoded fourth aggregated information. Thereby, the first information processing apparatus 100 may acquire the second aggregated information processed to suppress information leakage.

According to the first information processing apparatus 100, it is possible to transmit the generated fourth aggregated information to the second information processing apparatus 100. According to the first information processing apparatus 100, it is possible to receive, from the second information processing apparatus 100, the transmitted fourth aggregated information in which an order of the second aggregated information is randomized and resummarized. According to the first information processing apparatus 100, it is possible to determine whether or not the first user and the second user have a specific relationship based on the first aggregated information and the received fourth aggregated information in which an order of the second aggregated information is randomized and resummarized. Thereby, the first information processing apparatus 100 may hardly determine whether or not the second aggregated information is encoded by the information processing apparatus 100 corresponding to any user. Accordingly, the first information processing apparatus 100 may suppress information leakage.

According to the first information processing apparatus 100, it is possible to determine whether or not the first user and the second user have a specific relationship based on the first aggregated information and the fourth aggregated information encoded by the first information processing apparatus 100. Thereby, the first information processing apparatus 100 may suppress information leakage.

According to the first information processing apparatus 100, it is possible to determine whether or not the first user and the second user are indirectly connected to each other by a specific relationship through a third party. Thereby, the first information processing apparatus 100 may be applied to when the first user and the second user are indirectly connected to each other by a specific relationship through the third party.

A determination method described in the present embodiment may be realized by executing a previously prepared program with a computer such as a PC or a workstation. A determination program described in the present embodiment is recorded in a computer-readable recording medium and is executed by being read from the recording medium by a computer. The recording medium is a hard disc, flexible disc, a compact disc read-only memory (CD-ROM), a magneto optical disc (MO), a digital versatile disc (DVD), or the like. The determination program described in the present embodiment may be distributed through a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A determination method performed by a first apparatus corresponding to a first user, the determination method comprising:
acquiring, from a second apparatus corresponding to a second user which is different from the first user, first aggregated information in which identification information for identifying each user having a specific relationship with each user having a specific relationship with the first user is summarized;
acquiring, from the second apparatus, second aggregated information in which identification information for identifying each user having a specific relationship with the second user is summarized;
identifying a result which indicates a specific relationship between the first user and the second user based on the acquired first aggregated information and the acquired second aggregated information; and
outputting the identified result.

2. The determination method according to claim 1, wherein
the first aggregated information is information encoded by the second apparatus.

3. The determination method according to claim 1, wherein
the first aggregated information is information in which an order of identification information for identifying each user having a specific relationship with each user having a specific relationship with the first user is randomized and summarized by the second apparatus.

4. The determination method according to claim 2, wherein
the acquiring of the first aggregated information includes:
acquiring, from an apparatus corresponding to each user having a specific relationship with the first user, identification information for identifying each user having a specific relationship with the user and transmitting the acquired identification information to the second apparatus; and
acquiring, from the second apparatus, the first aggregated information which is transmitted and in which identification information for identifying each user having a specific relationship with each user having a specific relationship with the first user is summarized.

5. The determination method according to claim 4, wherein
the acquiring of the first aggregated information includes:
acquiring, from an apparatus corresponding to each user having a specific relationship with the first user, identification information which is encoded by the apparatus for identifying each user having a specific relationship with the user;
transmitting the acquired identification information to the second apparatus; and
acquiring, from the second apparatus, the first aggregated information which is transmitted and is encoded by an apparatus corresponding to each user having a specific relationship with the first user and in which identification information for identifying each user having a specific relationship with the user is summarized.

6. The determination method according to claim 5, wherein
the acquiring of the first aggregated information includes:
encoding identification information for identifying each user having a specific relationship with each user having a specific relationship with the first user by using an own apparatus, and transmitting the encoded identification information to the second apparatus; and
acquiring, from the second apparatus, the first aggregated information which is encoded by the apparatus and transmitted and in which identification information for identifying each user having a specific relationship with each user having a specific relationship with the first user is summarized.

7. The determination method according to claim 1, wherein
the second aggregated information is information encoded by the second apparatus.

8. The determination method according to claim 1, further comprising:
transmitting the acquired second aggregated information to an apparatus corresponding to each user having a specific relationship with the first user;
receiving the transmitted second aggregated information encoded by an apparatus corresponding to each user having a specific relationship with the first user; and
generating third aggregated information which is encoded by an apparatus corresponding to each user having a specific relationship with the first user and in which the received second aggregated information is summarized, wherein
the identifying includes
determining whether or not the first user and the second user have a specific relationship based on the first aggregated information and the generated third aggregated information.

9. The determination method according to claim 8, further comprising:
transmitting the generated third aggregated information to the second apparatus; and
receiving, from the second apparatus, the transmitted third aggregated information encoded by the second apparatus, wherein
the identifying includes
determining whether or not the first user and the second user have a specific relationship based on the first aggregated information and the received third aggregated information encoded by the second apparatus.

10. The determination method according to claim 8, further comprising:
transmitting the generated third aggregated information to the second apparatus; and
receiving, from the second apparatus, the transmitted third aggregated information in which an order of the second aggregated information is randomized and resummarized by the second apparatus, wherein
the identifying includes
determining whether or not the first user and the second user have a specific relationship based on the first aggregated information and the received third aggregated information in which the order of the second aggregated information is randomized and resummarized by the second apparatus.

11. The determination method according to claim 8, wherein
the identifying includes
determining whether or not the first user and the second user have a specific relationship based on the first aggregated information and the third aggregated information encoded by an own apparatus.

12. The determination method according to claim 1, wherein
The identifying includes
determining whether or not the first user and the second user are indirectly connected to each other by a specific relationship through a second party of any user having a specific relationship with the first user and any user having a specific relationship with the second user.

13. An information processing apparatus, comprising:
a memory; and
a processor coupled to the memory and configured to:
acquire, from a second apparatus corresponding to a second user which is different from the first user, first aggregated information in which identification information for identifying each user having a specific relationship with each user having a specific relationship with the first user is summarized;
acquire, from the second apparatus, second aggregated information in which identification information for identifying each user having a specific relationship with the second user is summarized;
identify a result which indicates a specific relationship between the first user and the second user based on the acquired first aggregated information and the acquired second aggregated information; and
output the identified result.

14. The information processing apparatus according to claim 13, wherein
the first aggregated information is information encoded by the second apparatus.

15. The information processing apparatus according to claim 13, wherein
the first aggregated information is information in which an order of identification information for Identifying each user having a specific relationship with each user having a specific relationship with the first user is randomized and summarized by the second apparatus.

16. The information processing apparatus according to claim 14, wherein of the processor is configured to:
acquire, from an apparatus corresponding to each user having a specific relationship with the first user, identification information for identifying each user having a specific relationship with the user and transmit the acquired identification information to the second apparatus, and
acquire, from the second apparatus, the first aggregated information which is transmitted and in which identification information for identifying each user having a specific relationship with each user having a specific relationship with the first user is summarized.

17. The information processing apparatus according to claim 16, wherein the processor is configured to:
acquire, from an apparatus corresponding to each user having a specific relationship with the first user, identification information, which is encoded by the apparatus, for identifying each user having a specific relationship with the user, and transmit the acquired identification information to the second apparatus, and
acquire, from the second apparatus, the first aggregated information which is transmitted and is encoded by an apparatus corresponding to each user having a specific relationship with the first user and in which identification information for identifying each user having a specific relationship with the user is summarized.

18. The information processing apparatus according to claim 17, wherein the processor is configured to:
encode identification information for identifying each user having a specific relationship with each user having a specific relationship with the first user by using an own apparatus, and transmit the encoded identification information to the second apparatus, and
acquire, from the second apparatus, the first aggregated information which is encoded by the apparatus and transmitted and in which identification information for identifying each user having a specific relationship with each user having a specific relationship with the first user is summarized.

19. The information processing apparatus according to claim 13, wherein
the second aggregated information is information encoded by the second apparatus.

20. The information processing apparatus according to claim 13, wherein the processor is configured to:
transmit the acquired second aggregated information to an apparatus corresponding to each user having a specific relationship with the first user,
receive the transmitted second aggregated information encoded by an apparatus corresponding to each user having a specific relationship with the first user,
generate third aggregated information which is encoded by an apparatus corresponding to each user having a specific relationship with the first user and in which the received second aggregated information is summarized, and
determine whether or not the first user and the second user have a specific relationship based on the first aggregated information and the generated third aggregated information.
